(19) United States
(12) Patent Application Publication
(10) Pub. No.: US 2022/0332969 A1
(43) Pub. Date: Oct. 20, 2022

(54) HIGH PERFORMANCE, RAPID CURE COATINGS

(71) Applicant: BASF SE, Ludwigshafen am Rhein (DE)

(72) Inventors: Sridhar G. IYER, Charlotte, NC (US); Vincent J. GOLDMAN, Waterford Township, MI (US); Michael A. GUIBAULT, Charlotte, NC (US); Jennifer Summerhill ZIGMOND, Florham Park, NJ (US); Michael KRAYER, Charlotte, NC (US); Luke S. EGAN, Charlotte, NC (US); Antonia Yunn CHAN, Charlotte, NC (US)

(21) Appl. No.: 17/640,806

(22) PCT Filed: Sep. 3, 2020
(86) PCT No.: PCT/US2020/049293

§ 371 Date: Mar. 5, 2022

Related U.S. Application Data
(60) Provisional application No. 62/896,842, filed on Sep. 6, 2019.

(51) Int. Cl. C09D 133/04; C09D 5/18; C09D 7/20; C09D 7/61; C09D 7/40; C09D 7/43; C09D 7/65; E04D 7/00; E04B 1/66; B05D 1/34; B05D 1/02

(52) U.S. Cl. CPC C09D 133/04; C09D 5/185; C09D 7/20; C09D 7/61; C09D 7/69; C09D 7/43; C09D 7/65; E04D 7/00; E04B 1/66; B05D 1/34; B05D 1/02

(57) ABSTRACT

Aqueous coating compositions as well as methods of using thereof are described. The coating compositions can be a two-part aqueous coating composition. The first coating component can comprise one or more polymers and the second coating component can comprise a catalyst such as phosphoric acid. The first coating component and the second coating component can be provided as separate aqueous compositions. The first coating component and a second coating component that can be co-applied (e.g., simultaneously or sequentially) to a surface form a rapid set coating.

### BACKGROUND

The formation of durable, high quality coatings on exterior surfaces poses numerous challenges. Notably, coatings on exterior surfaces typically remain exposed to the elements during application and drying. As a result, weather conditions during coating application and drying can impact the quality of exterior coatings. For example, rainfall during and/or after coating applications can wash-off some or all the coating, resulting in coating failure. By shortening the setting (film forming) time of coatings, instances of coating failure, such as those due to unanticipated rainfall, can be minimized. Further, aqueous acrylic roof coatings typically cannot be applied in a single coat to achieve the desired film thickness due to film cracking upon curing, and as a result such coatings are often applied in multiple coats resulting in increased labor costs. In certain prefabricated applications, external methods of accelerating the curing of coatings are employed, such as dryers to speed up the curing process, resulting in increased energy costs.

Dual spray systems comprising of a coating and catalyst that is simultaneously sprayed to accelerate film formation are known. However, improvements including reduction of high-water swells, elimination of syneresis during storage, enhanced mechanical, adhesive, and textual properties, and spraying efficiency are desired with these coatings. The compositions and methods disclosed herein address these and other needs.

### SUMMARY

Aqueous coating compositions as well as methods of using thereof are described. The coating compositions can include two-parts comprising a first coating component and a second coating component that can be co-applied (e.g., simultaneously or sequentially) to form a rapid set coating. The first coating component can comprise a first polymer, and a filler, and the second coating component can comprise a catalyst as described herein. The catalysts enable rapid film formation of the coating and significantly reduces the water swelling properties of the coating. In some embodiments, the first coating component can have a viscosity of from 50 KU to 120 KU or from 50 KU to 100 KU, measured using a Stormer viscometer.

The first polymer can be selected from an acrylic homopolymer, an acrylic-based copolymer, a styrene-acrylic-based copolymer, a styrene-butadiene-based copolymer, a vinyl acrylic-based copolymer, a vinyl aromatic-based copolymer, an ethylene vinyl acetate-based copolymer, a polychloroprene, an alkyd resin, a polyester resin, a polyurethane resin, an epoxy resin, or a blend thereof. In certain embodiments, the first polymer can be an acrylic homopolymer, an acrylic-based copolymer, a styrene-acrylic-based copolymer, or a combination thereof. In other embodiments, the first polymer can be a styrene-butadiene based copolymer. In further embodiments, the first polymer can be derived from an acid monomer, a phosphate monomer, or a combination thereof. Examples of acid monomers include acrylic acid, methacrylic acid, itaconic acid, maleic acid, fumaric acid, and combinations thereof. In other further embodiments, the first polymer can be derived from a crosslinkable monomer, a ureido-functional monomer such as ureido methacrylate, a (meth)acrylamide monomer, or a combination thereof. Examples of crosslinkable monomers include diacetone acrylamide (DAAM), adipic dihydrazide (ADDH), a monomer comprising 1,3-diketo groups such as acetoacetoxyethyl methacrylate (AAEM), a silane crosslinker, and a combination thereof, such as a combination of diacetone acrylamide and adipic dihydrazide. The first polymer can have a T_{g} of from −70° C. to 50° C., from −40° C. to 25° C., or from −50° C. to 0° C. The first polymer can further have a particle size ranging from 40 nm to 400 nm, such as from 50 nm to 200 nm. The first polymer can have a molecular weight ranging from 10,000 to 10,000,000 Daltons, such as from 10,000 to 3,000,000 Daltons or from 200,000 to 1,000,000 Daltons. In some embodiments of the aqueous coating composition, the first coating component comprises i) from 20% to 60% (e.g., from 30-60% or from 35-55%) by weight of a first polymer, based on the weight of the first coating component and ii) from 10% to 70% (e.g., from 10% to 50% by weight, or from 15% to 40%) by weight of a filler, based on the weight of the first coating component.

The first coating component can further comprise a second polymer. The second polymer can have a T_{g} of from −70° C. to 50° C., or from −40° C. to 25° C., or from −50° C. to 0° C.

The filler in the first coating component can be selected from aluminum silicate (e.g., kaolin or halloysite), titanium dioxide, calcium carbonate, barium sulfate, aluminum oxide, silicon dioxide, magnesium oxide, talc, nepheline syenite, feldspar, diatomaceous earth, mica, perlite, wollastonite, or a mixture thereof.

In other embodiments of the aqueous coating composition, the first coating component comprises i) from 20% to 60% by weight of a first polymer based on the weight of the first coating component, ii) at least 10% by weight based on the weight of the first coating component of a functional filler selected from kaolin, halloysite, barium sulfate, calcium carbonate, or a mixture thereof, wherein the functional filler has an average particle size diameter of 3 microns or less, as determined by Sedigraph 5100 Particle Size Analyzer, and iii) an additional filler having an average particle size diameter of 10 microns or greater, as determined by Sedigraph 5100 Particle Size Analyzer. Improved mechanical and adhesive properties of the coatings were achieved by optimizing filler particle sizes for increased tensile and elongation of the films and enhanced adhesion across diverse substrates. For example, replacing 25% of a 10 micron calcium carbonate with a blend of very low particle size (less than 3 microns) functional filler, resulted in about 20% improvement in the tensile and adhesive properties of the coating.

In some examples, the functional filler includes kaolin. The average particle size diameter of the functional filler can be from 0.2 to 3 microns, from 0.2 to 1 micron, or from 0.3 to 0.8 microns. The functional filler can be present in an amount of from 10% to 70% by weight, from 10% to 50% by weight, or from 15% to 40% by weight, based on the weight of the first coating component. The additional filler can include any one of the fillers having an average particle size diameter of 10 microns or greater, as described herein. The functional filler and the additional filler can be present in a weight ratio from 1:20 to 20:1, from 1:10 to 1:1, or from 1:8 to 1:2. The functional filler and the additional filler can be present in an amount of from 10% to 70% by weight, from 10% to 50% by weight, or from 15% to 40% by weight, based on the weight of the first coating component.

In addition to the polymer and filler, the first coating component can further comprise a thickener. The thickener can include an alkali swellable thickener such as an anionic, hydrophobically modified alkali swellable emulsion (HASE) polyacrylate copolymer; a non-ionic associative thickener; an attapulgite clay; a cellulosic thickener; or a combination thereof. The thickener not only enables the formulation of low viscosity coatings with efficient spray qualities, but also eliminates syneresis typically observed with cellulosic thickeners. The thickener can be present in an amount from greater than 0% to 5% by weight, from 0.15% to 2.5% by weight, or from 0.15% to 0.5% by weight, based on the weight of the first coating component. The thickener essentially eliminated the syneresis of the coating without significantly elevating the viscosity of the coatings.

The first coating component can further comprise an additive selected from a coalescent agent, a pigment dispersant, a defoamer, a wetting agent, an adhesion promoter, or a combination. The additive can be present in an amount of 10% by weight or less or 5% by weight or less of the first coating component.

In some embodiments of the aqueous coating composition, the second coating component comprises a catalyst selected from a phosphoric acid catalyst, aluminum sulfate, formic acid, polyaluminum chloride, polyvinyl amine having a molecular weight from about 3,000 Da to about 35,000 Da, or a mixture thereof, or a mixture thereof. In some examples, the second coating component comprises a phosphoric acid catalyst. The phosphoric acid catalyst can be selected from H₃PO₄ or a polyphosphoric acid compound represented by the formula, Hₙ₊₂PₙO₃ₙ₊₁, wherein n is an integer from 2 to 30. The catalyst (e.g., the phosphoric acid catalyst) can be present in an amount of from 0.03% to less than 5% by weight, or from 0.05% to less than 5% by weight, based on the weight of the aqueous coating composition.

The first coating component and the second coating component, when cosprayed to form a film and dried for 14 days, can exhibit a tensile strength from greater than 200 psi to 300 psi, or from greater than 200 psi to 250 psi, as determined by ASTM D 2370. The first coating component and the second coating component, when cosprayed to form a film and dried for 14 days, can exhibit an elongation at break of greater than 100%, greater than 120%, or from greater than 100% to 180%, as determined by ASTM D-2370. The first coating component and the second coating component, when cosprayed to form a film and dried and weathered for 1000 hours at 23° C., can exhibit an elongation at break of greater than 100%, greater than 120%, greater than 140%, or from greater than 100% to 180%, as determined by ASTM D-2370.

The first coating component and the second coating component, when cosprayed to form a film and dried for 14 days, can exhibit a water absorption after 7 days soaking in water, of less than 15% by weight, preferably less than 10% by weight, more preferably less than 8% by weight, based on the weight of the film, as determined by ASTM D-471.

Sprayed films derived from the aqueous coating compositions are also disclosed herein. The sprayed film can comprise a) from 25% to 75% by weight, based on a dry weight of the sprayed film, of a first polymer selected from an acrylic homopolymer or an acrylic copolymer; b) from 20% to 70% by weight, based on the dry weight of the sprayed film, of a filler, and c) a phosphoric acid catalyst, wherein the sprayed film, passes the Standard Specification for Liquid Applied Acrylic Coating test set forth in ASTM D 6083-97. In some embodiments, however, the sprayed film can comprise the first coating component as described herein, without a catalyst. For example, the sprayed film can comprise a) from 25% to 75% by weight, based on a dry weight of the sprayed film, of a first polymer selected from an acrylic homopolymer or an acrylic copolymer; b) from 10% to 70% by weight of a functional filler, based on the dry weight of the sprayed film, wherein the functional filler is selected from kaolin, halloysite, barium sulfate, calcium carbonate, or a mixture thereof, wherein the functional filler has an average particle size diameter of 3 microns or less, as determined by Sedigraph 5100 Particle Size Analyzer, and c) an additional filler having an average particle size diameter of 10 microns or greater, as determined by Sedigraph 5100 Particle Size Analyzer; wherein the sprayed film, passes the Standard Specification for Liquid Applied Acrylic Coating test set forth in ASTM D 6083-97. The sprayed films can exhibit a tensile strength, an elongation at break, and/or water absorption as described herein for the aqueous coating compositions.

Roof coatings, architectural coatings, and industrial coatings derived from the aqueous coating compositions are also disclosed. Barrier coatings derived from the aqueous coating compositions are also disclosed. The barrier coating when dried, can exhibit barrier properties to air, water vapor, or liquid water. In some embodiments, the barrier coating comprises a) from 20% to 85% by weight of a first polymer, based on the dry weight in the barrier composition, b) from 10% to 70% (e.g., from 10%-50% by weight, or from 15% to 40% by weight) by weight of a filler, based on the dry weight in the barrier composition, c) a phosphoric acid catalyst, and d) one or more additives selected from a coalescent agent, a pigment dispersant, a defoamer, a wetting agent, an adhesion promoter, or a combination. The first polymer can be derived from an acrylic homopolymer, an acrylic-based copolymer, a styrene-acrylic-based copolymer, a vinyl acrylic-based copolymer, an ethylene vinyl acetate-based copolymer, a polyurethane resin, or a combination thereof. The barrier coatings can further comprise a functional filler selected from kaolin, halloysite, barium sulfate, calcium carbonate, or a mixture thereof, wherein the functional filler has an average particle size diameter of 3 microns or less, as determined by Sedigraph 5100 Particle Size Analyzer.

The barrier coatings after spraying and drying, can exhibit a vapor permeability of greater than 0.1 US perms or greater than 1 US perm.

The barrier coating can be provided as a coating on metal, asphalt, wet or dry concrete, stone, ceramic, wood, plastic, polyurethane foam, glass, masonry or cinder blocks, stucco, manufactured board (e.g., cement board, gypsum board, expanded polystyrene (EPS) board, an oriented strand board (OSB)), or another coating layer applied on a substrate. The surface can be a roof or a wall surface.

Intumescent coatings derived from the aqueous coating compositions are also disclosed. The intumescent coatings can include a first coating component comprising a first polymer and optionally a second polymer; a second coating component comprising a catalyst; and an additive comprising an intumescent agent, a vibration damping agent, an insulation agent, or a combination of two or more thereof. The additive can be present in the first coating component, the second coating component, or both the first and second coating components. The intumescent agent can comprise an acid source, a carbon source, and a gas forming agent; the vibration damping agent can comprise a first filler; and the insulation agent can comprise a second filler.

Methods of coating a surface comprising applying an aqueous coating composition comprising a first coating component and a second coating component as described herein, wherein the first coating component is applied (sprayed) at a pressure of from greater than 300 psi up to 3,000 psi, such as from greater than 300 psi to 1,500 psi, and the second coating component is applied (sprayed) at a pressure of from 30 psi to 300 psi to the surface are also described. In certain embodiments, the first coating component can be applied at a pressure of from 900 psi to 1,200 psi, and the second coating component can be applied at a pressure of from 50 psi to 150 psi to the surface. The texture of the coating film was greatly improved by adopting high coating pressures while increasing the catalyst pressure. The coating output was also greatly improved at these pressures without adversely impacting the performance qualities of the coating. The aqueous coating composition can be applied (sprayed) at a rate of greater than 1.7 gallons/minute, from 1.7 to 4 gallons/minute, or from 2.5 to 4 gallons/minute onto the surface. The first coating component and the second coating component can be simultaneously applied to the surface.

The aqueous coating composition after drying as a film, can exhibit a smooth surface. The surface roughness can be determined by a MultiMode™ 8 Atomic Force Microscope (AFM) using a Si₃N₄ probe.

The details of one or more embodiments are set forth in the description below. Other features, objects, and advantages will be apparent from the description and from the claims.

### DESCRIPTION OF THE DRAWINGS

FIG. 1 shows a comparison of the properties of conventional and inventive film when sprayed.

### DETAILED DESCRIPTION

As used herein, “(meth)acryl . . . ” includes acryl . . . , methacryl . . . , diacryl . . . , and dimethacryl . . . , polyacryl . . . and polymethacryl . . . . or mixtures thereof. For example, the term “(meth)acrylate monomer” includes acrylate, methacrylate, diacrylate, dimethacrylate, polyacrylate and polymethacrylate monomers.

Provided herein are aqueous coating compositions. The aqueous coating compositions can include a first coating component and a second coating component. The two coating components can be co-applied (cosprayed) to a surface (e.g., simultaneously or sequentially) to form a rapid set coating.

The first coating component can comprise a first polymer. The first polymer can be a homopolymer or a copolymer. The first polymer can be a pure acrylic polymer (i.e., a polymer derived exclusively from (meth)acrylate monomers), a styrene-acrylic-based copolymer (i.e., a polymer derived from styrene and one or more (meth)acrylate monomers), a styrene-butadiene-based copolymer (i.e., a polymer derived from butadiene and styrene monomers), a styrene-butadiene-styrene block copolymer, a vinyl-acrylic-based copolymer (i.e., a polymer derived from one or more vinyl ester monomers and one or more (meth)acrylate monomers), a vinyl aromatic-based copolymer (i.e., a polymer derived from one or more vinyl aromatic monomers such as styrene), a vinyl chloride-based copolymer (i.e., a polymer derived from one or more vinyl chloride monomers), a vinylidene fluoride-based copolymer (i.e., a polymer derived from one or more vinylidene fluoride monomers), a silicone-based polymer (i.e., a polymer derived from one or more silicone monomers), a polyurethane-based polymer, an acrylic-polyurethane-based hybrid copolymer, a vinyl alkanoate-based copolymer (i.e., a polymer derived from one or more vinyl alkanoate monomers, such as polyvinyl acetate or a copolymer derived from ethylene and vinyl acetate monomers such as an ethylene vinyl acetate-based copolymer), polychloroprene, alkyd resin, polyester resin, epoxy resin, copolymers thereof, blends thereof, or combinations thereof.

In certain embodiments, the first polymer (e.g., an acrylic homopolymer or a styrene-acrylic based copolymer) can be derived from one or more (meth)acrylate and/or (meth)acrylic acid monomers. Suitable (meth)acrylate monomers include esters of α,β-monoethylenically unsaturated mono- and dicarboxylic acids having 3 to 6 carbon atoms with alkanols having 1 to 12 carbon atoms (e.g. esters of acrylic acid, methacrylic acid, maleic acid, fumaric acid, or itaconic acid, with C₁-C₁₂, C₁-C₈, or C₁-C₄ alkanols such as ethyl, n-butyl, isobutyl and 2-ethylhexyl acrylates and methacrylates, dimethyl maleate and n-butyl maleate). Specific examples of suitable (meth)acrylate monomers for use in the polymer binder include methyl (meth)acrylate, ethyl (meth)acrylate, n-butyl (meth)acrylate, iso-butyl (meth)acrylate, tert-butyl (meth)acrylate, isobutyl (meth)acrylate, n-hexyl (meth)acrylate, 2-ethylhexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, heptadecyl (meth)acrylate, lauryl (meth)acrylate, tridecyl (meth)acrylate, stearyl (meth)acrylate, glycidyl (meth)acrylate, allyl (meth)acrylate, tetrahydrofurfuryl (meth)acrylate, cyclohexyl (meth)acrylate, 2-propylheptyl (meth)acrylate, behenyl (meth)acrylate, or combinations thereof. Other suitable (meth)acrylate monomers include alkyl crotonates, acetoacetoxyethyl (meth)acrylate, acetoacetoxypropyl (meth)acrylate, hydroxyethyl (meth)acrylate, 2-ethoxyethyl (meth)acrylate, 2-methoxy (meth)acrylate, 2-(2-ethoxyethoxy)ethyl (meth)acrylate, 2-phenoxyethyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, or combinations thereof.

The first polymer can include a (meth)acrylate monomer in an amount of 5% or greater by weight, based on the weight of the polymer. For example, the (meth)acrylate monomer can be in an amount of 7% or greater, 10% or greater, 20% or greater, 30% or greater, 40% or greater, 50% or greater, 60% or greater, 65% or greater, 70% or greater, 75% or greater, 80% or greater, 85% or greater, 90% or greater, 95% or greater, or up to 100% by weight, based on the weight of the polymer. In some embodiments, the (meth)acrylate monomer can be in an amount of 100% or less, 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the first polymer. The first polymer can be derived from any of the minimum values to any of the maximum values by weight described above of the (meth)acrylate monomers. For example, the (meth)acrylate monomer can be in an amount of from greater than 0% to 100%, 20% to 100%, 40% to 95%, 50% to 95%, 65% to 95%, or 65% to 85% by weight, based on the weight of the first polymer.

In certain embodiments, the first polymer can be derived from (meth)acrylic acid monomers, a phosphate monomer, or a combination thereof. Examples of suitable (meth)acrylic acid monomers include α,β-monoethylenically unsaturated mono- and dicarboxylic acids having 3 to 6 carbon atoms. Specific examples of suitable (meth)acrylic acid monomers include acrylic acid, methacrylic acid, maleic acid, fumaric acid, or itaconic acid, crotonic acid, dimethacrylic acid, ethylacrylic acid, allylacetic acid, vinylacetic acid, mesaconic acid, methylenemalonic acid, citraconic acid, or mixtures thereof. The first polymer can be derived from 0%, 0.5% or greater, 1.0% or greater, 1.5% or greater, 2.5% or greater, 3.0% or greater, 3.5% or greater, 4.0% or greater, or 5.0% or greater, by weight of a (meth)acrylic acid monomer. In some embodiments, the first polymer can be derived 25% or less, 20% or less, 15% or less, or 10% or less, by weight of a (meth)acrylic acid monomer. In some embodiments, the first polymer can be derived from 0.5%-25%, from 0.5%-10%, from 1.0%-9%, from 2.0%-8% or from 0.5%-5%, by weight of a (meth)acrylic acid monomer.

Examples of suitable phosphate monomers include phosphoric acid 2-hydroxyethyl methacrylate ester. The first polymer can be derived from 0%, 0.5% or greater, 1.0% or greater, 1.5% or greater, 2.5% or greater, 3.0% or greater, 3.5% or greater, 4.0% or greater, or 5.0% or greater, by weight of a phosphate monomer. In some embodiments, the first polymer can be derived 25% or less, 20% or less, 15% or less, or 10% or less, by weight of a phosphate monomer. In some embodiments, the first polymer can be derived from 0.5%-25%, from 0.5%-10%, from 1.0%-9%, from 2.0%-8% or from 0.5%-5%, by weight of a phosphate monomer.

In certain embodiments, the first polymer includes vinyl aromatic monomers (e.g., styrene). For example, the first polymer can include a styrene-acrylic-based copolymer, a styrene-butadiene-based copolymer, a styrene-butadiene-styrene block copolymer, or a mixture thereof. Suitable vinyl aromatic monomers for use in the copolymers can include styrene or an alkyl styrene such as α- and p-methylstyrene, α-butylstyrene, p-n-butylstyrene, p-n-decylstyrene, vinyltoluene, and combinations thereof. The vinyl aromatic monomer can be present in an amount of 0% by weight or greater (e.g., 1% or greater, 2% or greater, 5% or greater, 10% or greater, 15% or greater, 20% or greater, 25% or greater, 30% or greater, 40% or greater, 50% or greater, 60% or greater, 65% or greater, 70% or greater, 75% or greater, 80% or greater, or 85% or greater by weight), based on the total weight of monomers from which the first polymer is derived. In some embodiments, the vinyl aromatic monomer can be present in the polymer in an amount of 90% by weight or less (e.g., 85% or less, 80% or less, 75% or less, 70% or less, 65% or less, 60% or less, 55% or less, 50% or less, 45% or less, 40% or less, 35% or less, 30% or less, 25% or less, 15% or less, or 10% or less by weight), based on the total weight of monomers from which the first polymer is derived. The first polymer can be derived from any of the minimum values to any of the maximum values by weight described above of the vinyl aromatic monomer. For example, the first polymer can be derived from 0% to 90% by weight (e.g., from 0% to 60%, from 0% to 45%, from 2% to 85%, from 2% to 60%, from 2% to 40%, from 5% to 85%, from 5% to 75%, from 5% to 60%, from 5% to 50%, from 5% to 35%, from 0% to 15%, from 0% to 10%, from 2% to 10%, or from 0% to 5% by weight of vinyl aromatic monomer), based on the total weight of monomers from which the first polymer is derived.

When used, the styrene-acrylic-based copolymer can include styrene, a (meth)acrylate monomer, and optionally, one or more additional monomers. In some embodiments, the weight ratio of styrene to the (meth)acrylate monomer in the first polymer can be from 1:99 to 99:1, from 10:99 to 99:10, from 5:95 to 95:5, from 5:95 to 80:20, from 20:80 to 80:20, from 5:95 to 70:30, from 30:70 to 70:30, or from 40:60 to 60:40. For example, the weight ratio of styrene to the (meth)acrylate monomer can be 25:75 or greater, 30:70 or greater, 35:65 or greater, or 40:60 or greater. In some examples, the first polymer can be a random copolymer, such as a random styrene-(meth)acrylate copolymer.

In certain embodiments, the first polymer can be derived from one or more ethylenically-unsaturated monomers selected from anhydrides of α,β-monoethylenically unsaturated mono- and dicarboxylic acids (e.g. maleic anhydride, itaconic anhydride, and methylmalonic anhydride); acrylamides and alkyl-substituted acrylamides (e.g. (meth)acrylamide, N-tert-butylacrylamide, and N-methyl(meth)acrylamide); (meth)acrylonitrile; 1,2-butadiene (i.e. butadiene); vinyl and vinylidene halides (e.g. vinyl chloride and vinylidene chloride); vinyl esters of C₁-C₁₈ mono- or dicarboxylic acids (e.g. vinyl acetate, vinyl propionate, vinyl n-butyrate, vinyl laurate and vinyl stearate); C₁-C₄ hydroxyalkyl esters of C₃-C₆ mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mole of ethylene oxide, propylene oxide, butylene oxide or mixtures thereof (e.g. hydroxyethyl (meth)acrylate, hydroxypropyl (meth)acrylate, and methylpolyglycol acrylate); monomers containing glycidyl groups (e.g. glycidyl methacrylate); linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-N-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate, and sulfopropyl methacrylate); vinylphosphonic acid, dimethyl vinylphosphonate, and other phosphorus monomers (e.g., phosphoethyl (meth)acrylate); alkylaminoalkyl (meth)acrylates or alkylaminoalkyl(meth)acrylamides or quaternization products thereof (e.g., 2-(N,N-dimethylamino)ethyl (meth)acrylate, 3⁻(N,N-dimethylamino)propyl (meth)acrylate, 2-(N,N,N-trimethylammonium) ethyl (meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C₁-C₃₀ monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine); monomers containing 1,3-diketo groups (e.g., acetoacetoxyethyl (meth)acrylate or diacetone acrylamide); monomers containing urea or ureido groups (e.g., ureido methacrylate, ureidoethyl (meth)acrylate, acrylamidoglycolic acid, and methacrylamidoglycolate methyl ether); monoalkyl itaconates; monoalkyl maleates; hydrophobic branched ester monomers; monomers containing silyl groups (e.g., trimethoxysilylpropyl methacrylate), vinyl esters of branched mono-carboxylic acids having a total of 8 to 12 carbon atoms in the acid residue moiety and 10 to 14 total carbon atoms such as, vinyl 2-ethylhexanoate, vinyl neo-nonanoate, vinyl neo-decanoate, vinyl neo-undecanoate, vinyl neo-dodecanoate and mixtures thereof, and copolymerizable surfactant monomers (e.g., those sold under the trademark ADEKA REASOAP).

The first polymer can include one or more crosslinking monomers. Exemplary crosslinking monomers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glycidyl (meth)acrylate; glyoxal based crosslinkers; monomers containing two vinyl radicals; monomers containing two vinylidene radicals; and monomers containing two alkenyl radicals. Other crosslinking monomers include, for instance, diesters of dihydric alcohols with α,β-monoethylenically unsaturated monocarboxylic acids, of which in turn acrylic acid and methacrylic acid can be employed. Examples of such monomers containing two non-conjugated ethylenically unsaturated double bonds can include alkylene glycol diacrylates and dimethacrylates, such as ethylene glycol diacrylate, 1,3-butylene glycol diacrylate, 1,4-butylene glycol diacrylate and propylene glycol diacrylate, divinylbenzene, vinyl methacrylate, vinyl acrylate, allyl methacrylate, allyl acrylate, diallyl maleate, diallyl fumarate, methylenebisacrylamide, and mixtures thereof. The crosslinkable monomer can include diacetone acrylamide (DAAM), adipic dihydrazide (ADDH), or a self-crosslinking monomer such as a monomer comprising 1,3-diketo groups or a silane crosslinker. Examples of monomers comprising 1,3-diketo groups include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Examples of suitable silane crosslinkers include 3-methacryloxypropyl trimethoxysilane, 3-mercaptopropyl trimethoxysilane, vinyl-triethoxysilane, and polyvinyl-siloxane oligomers such as DYNASYLAN 6490, a polyvinyl siloxane oligomer derived from vinyltrimethoxysilane, and DYNASYLAN 6498, a polyvinyl siloxane oligomer derived from vinyltriethoxysilane, both commercially available from Evonik Degussa GmbH (Essen, Germany). The polyvinyl siloxane oligomer can have the following structure:

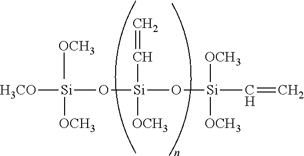

wherein n is an integer from 1 to 50 (e.g., 10). Crosslinkable monomers as described herein can further include monomers such as divinylbenzene; 1,4-butanediol diacrylate; methacrylic acid anhydride; and monomers containing urea groups (e.g., ureidoethyl (meth)acrylate, acrylamidoglycolic acid, and methacrylamidoglycolate methyl ether. In some examples, the first polymer and/or the second polymer can include from 0 to 5% by weight of one or more crosslinkable monomers.

In some embodiments, the first polymer can be derived from an acrylic homopolymer, an acrylic-based copolymer, a styrene-acrylic-based copolymer, or a combination thereof. In some embodiments, the first polymer can be an anionically stabilized polymer, such as an anionically stabilized acrylic-based polymer. Acrylic-based polymers include polymers derived from one or more (meth)acrylate monomers such as pure acrylics, styrene acrylics, and vinyl acrylics. In some embodiments, the polymer is produced by emulsion polymerization.

The first polymer can have a measured glass-transition temperature (T_{g}) of from −70° C. to 50° C. In this application, the measured glass-transition temperature is measured by differential scanning calorimetry (DSC) using the mid-point temperature as described, for example, in ASTM 3418/82. In some embodiments, the first polymer has a measured T_{g} of −70° C. or greater (for example, −60° C. or greater, −50° C. or greater, −40° C. or greater, −30° C. or greater, −20° C. or greater, −10° C. or greater, 0° C. or greater, 10° C. or greater, 20° C. or greater, 30° C. or greater, 40° C. or greater, or 50° C. or greater). In some cases, the first polymer has a measured T_{g} of 50° C. or less (e.g., less than 50° C., 40° C. or less, 30° C. or less, 25° C. or less, 20° C. or less, 10° C. or less, 0° C. or less, −10° C. or less, −20° C. or less, −25° C. or less, −30° C. or less, −35° C. or less, −40° C. or less, −45° C. or less, or −50° C. or less). In certain embodiments, the first polymer has a measured T_{g} of from −70° C. to 50° C., from −70° C. to 40° C., from −70° C. to 30° C., from −70° C. to 25° C., −70° C. to 0° C., −70° C. to −10° C., from −60° C. to 30° C., from −60° C. to 25° C., from −60° C. to 0° C., from −60° C. to less than 0° C., from −40° C. to less than 25° C., from −40° C. to less than 10° C., or from −40° C. to less than 0° C.

The first polymer can comprise particles having a number average particle size of 400 nm or less (e.g., 380 nm or less, 360 nm or less, 350 nm or less, 320 nm or less, 300 nm or less, 280 nm or less, 270 nm or less, 260 nm or less, 250 nm or less, 240 nm or less, 230 nm or less, 210 nm or less, 200 nm or less, 180 nm or less, 160 nm or less, 150 nm or less, 140 nm or less, 130 nm or less, 120 nm or less, 110 nm or less, 100 nm or less, 95 nm or less, 90 nm or less, 80 nm or less, 70 nm or less, 60 nm or less, 50 nm or less, or 40 nm). In some embodiments, the first polymer can have a number average particle size of 40 nm or greater, 45 nm or greater, 50 nm or greater, 55 nm or greater, 60 nm or greater, 70 nm or greater, 80 nm or greater, 90 nm or greater, 100 nm or greater, 110 nm or greater, 120 nm or greater, 140 nm or greater, 150 nm or greater, 160 nm or greater, 180 nm or greater, 200 nm or greater, 220 nm or greater, 250 nm or greater, 280 nm or greater, 300 nm or greater, 320 nm or greater, 350 nm or greater, 360 nm or greater, 380 nm or greater, or 400 nm or greater. In some embodiments, the first polymer can have a number average particle size of from 40 nm to 400 nm, 40 nm to 350 nm, 50 nm to 300 nm, from 50 nm to 250 nm, from 50 nm to 200 nm, from 60 nm to 150 nm, or from 80 nm 150 nm. The particle size can be determined using dynamic light scattering measurements using the Nanotrac Wave II Q available from Microtrac Inc., Montgomeryville, Pa.

In some embodiments, the weight average molecular weight of the first polymer can be 10,000 Da or greater. In some embodiments, the molecular weight of the first polymer can be adjusted by adding a molecular weight regulator during polymerization, for example, 0.01 to 4% by weight, based on the monomers being polymerized, such that the weight average molecular weight of the first polymer is less than 10,000,000 Da. Particular regulators which can be used include organic thio compounds (e.g., tert-dodecylmercaptan), allyl alcohols, and aldehydes. Such substances are preferably added to the polymerization zone in a mixture with the monomers to be polymerized and are considered part of the total amount of unsaturated monomers used in the polymers. In some embodiments, the weight average molecular weight of the first polymer can be 50,000 Da or greater (e.g., 100,000 Da or greater, 200,000 Da or greater, 300,000 Da or greater, 400,000 Da or greater, 500,000 Da or greater, 600,000 Da or greater, 700,000 Da or greater, 800,000 Da or greater, 900,000 Da or greater, 1,000,000 Da or greater, 1,500,000 Da or greater, 2,000,000 Da or greater, 3,000,000 Da or greater, or up to 10,000,000 Da or greater). In some embodiments, the weight average molecular weight of the first polymer can be 10,000,000 Da or less (e.g., 8,000,000 Da or less, 6,000,000 Da or less, 5,000,000 Da or less, 3,000,000 Da or less, 2,000,000 Da or less, 1,000,000 Da or less, 900,000 Da or less, 800,000 Da or less, 700,000 Da or less, 600,000 Da or less, 500,000 Da or less, 400,000 Da or less, 300,000 Da or less, or 200,000 Da or less).

In some embodiments, the first coating component can further comprise a second polymer. The second polymer can be a polymer such as those described above with respect to the first polymer. For example, the second polymer can be an acrylic-based polymer (e.g., an acrylic polymer, a styrene-acrylic polymer, or a vinyl-acrylic polymer). In certain examples, the second polymer can be a polymer produced by emulsion polymerization and derived from two or more monomers including a (meth)acrylate monomer and an acid monomer.

The second polymer can have a measured T_{g} of at least of −90° C. or greater (e.g., −80° C. or greater, −70° C. or greater, −60° C. or greater, −50° C. or greater, −40° C. or greater, −30° C. or greater, −20° C. or greater, −15° C., at least −10° C., at least −5° C., at least 0° C., at least 5° C., at least 10° C., at least 15° C., at least 20° C., at least 25° C., at least 30° C., at least 35° C., at least 40° C., or at least 45° C.). In some embodiments, the second polymer can have a measured T_{g} of 100° C. or less (e.g., 90° C. or less, 80° C. or less, 70° C. or less, 60° C. or less, 50° C. or less, 45° C. or less, 40° C. or less, 35° C. or less, 30° C. or less, 25° C. or less, 20° C. or less, 15° C. or less, 10° C. or less, 5° C. or less, 0° C. or less, −5° C. or less, or −10° C. or less). The second polymer can have a measured T_{g} ranging from any of the minimum values described above to any of the maximum values described above. For example, the second polymer can have a measured T_{g} of from −90° C. to 90° C. (e.g., a T_{g} of from −90° C. to 50° C., from −90° C. to 40° C., from −90° C. to 30° C., from −90° C. to 25° C., −90° C. to 0° C., −90° C. to −10° C., from −80° C. to 25° C., from −80° C. to 10° C., from −80° C. to 0° C., from −80° C. to −10° C., from −60° C. to 30° C., from −60° C. to 25° C., from −60° C. to 0° C., from −60° C. to less than 0° C., from −40° C. to less than 25° C., from −40° C. to less than 10° C., or from −40° C. to less than 0° C., from −15° C. to 50° C., from −15° C. to 25° C., from −15° C. to 10° C., or from −15° C. to 0° C.).

When the first coating component comprises a first polymer and a second polymer, the first polymer and the second polymer can be present in the first coating component in varying amounts so as to provide a resultant coating with the desired properties for a particular application. For example, the first polymer can be present in the first coating component in an amount of at least 10% by weight (e.g., at least 20% by weight, at least 30% by weight, at least 40% by weight, at least 50% by weight, at least 60% by weight, at least 70% by weight, at least 80% by weight, or at least 90% by weight), based on the total polymer content of the first coating component. In some embodiments, the first polymer can be present in the first coating component in an amount of 90% or less by weight (e.g., 90% or less by weight, 80% or less by weight, 70% or less by weight, 60% or less by weight, 50% or less by weight, 40% or less by weight, 30% or less by weight, or 20% or less by weight), based on the total polymer content of the first coating component. The first polymer can be present in the first coating component in an amount ranging from any of the minimum values described above to any of the maximum values described above. For example, the first polymer can be present in the first coating component in an amount of 10%-90% by weight (e.g., 10%-60%, 10%-50%, 20%-60%, 20%-50% or 20%-40% by weight), based on the total polymer content of the first coating component.

The second polymer can be present in the first coating component in an amount of at least 10% by weight (e.g., at least 20% by weight, at least 30% by weight, at least 40% by weight, at least 50% by weight, at least 60% by weight, at least 70% by weight, at least 80% by weight, or at least 90% by weight), based on the total polymer content of the first coating component. In some embodiments, the second polymer can be present in the first coating component in an amount of 90% or less by weight (e.g., 90% or less by weight, 80% or less by weight, 70% or less by weight, 60% or less by weight, 50% or less by weight, 40% or less by weight, 30% or less by weight, or 20% or less by weight), based on the total polymer content of the first coating component. The second polymer can be present in the first coating component in an amount ranging from any of the minimum values described above to any of the maximum values described above. For example, the second polymer can be present in the first coating component in an amount of 10%-90% by weight (e.g., 10%-60%, 10%-50%, 20%-60%, 20%-50% or 20%-40% by weight), based on the total polymer content of the first coating component.

The first polymer and the optional second polymer can be present in the first coating component in an amount of at least 10% by weight (e.g., at least 20% by weight, at least 30% by weight, at least 40% by weight, at least 50% by weight, or at least 60% by weight), based on the weight of the first coating component. In some embodiments, the first polymer and the second polymer can be present in the first coating component in an amount of 60% or less by weight (e.g., 50% or less by weight, 40% or less by weight, 30% or less by weight, or 20% or less by weight), based on the weight of the first coating component. The first polymer and the second polymer can be present in the first coating component in an amount ranging from any of the minimum values described above to any of the maximum values described above. For example, the first polymer and the second polymer can be present in the first coating component in an amount of 10%-60% by weight (e.g., 10%-50%, 20%-60%, 20%-50% or 20%-40% by weight), based on the weight of the first coating component.

In certain embodiments where the first coating component comprises a first polymer and a second polymer, the first polymer and the second polymer can exhibit differing T_{g} values. In some cases, the measured T_{g} of the first polymer can be less (e.g., at least 5° C. less, at least 10° C. less, at least 15° C. less, at least 20° C. less, or at least 25° C. less) than the measured T_{g} of the second polymer. For example, in some cases, the measured T_{g} of the first polymer can be from −50° C. to −23° C., −40° C. to −25° C., −30° C. to −25° C., −36° C. to −23° C., or −33° C. to −26° C., and the measured T_{g} of the second polymer can be from −12° C. to 25° C., −12° C. to 0° C., −10° C. to −2° C., −12° C. to 0° C., −9° C. to 5° C., or −5° C. to 0° C.

In some embodiments, the first polymer can be derived from one or more monomers including one of more of butyl acrylate and 2-ethylhexyl acrylate, one or more acid monomers, a crosslinkable monomer, and optionally styrene and/or methyl methacrylate. In certain embodiments, the first polymer comprises an acrylic-based polymer derived from:

(i) 5-25% by weight alkyl methacrylate;

(ii) 50-95% by weight alkyl acrylate;

(iv) 0 to 10% by weight acid monomers; and

(v) 0 to 5% by weight crosslinkable monomers.

In some embodiments, the first polymer comprises an acrylic-based polymer derived from

(i) 5-10% by weight methyl methacrylate;

(ii) 40-70% by weight butyl acrylate;

(iii) 10-30% by weight 2-ethylhexylacrylate;

(iv) 0 to 10% by weight acid monomers; and

(v) 0 to 5% by weight crosslinkable monomers.

In some embodiments, the first polymer can comprise a styrene acrylic-based polymer derived from:

(i) 40-55% by weight butyl acrylate;

(ii) 10-20% by weight 2-ethylhexylacrylate;

(iii) 25-40% by weight styrene;

(iv) 0 to 5% by weight acid monomers; and

(v) 0 to 5% by weight crosslinkable monomers.

Typical polymers used in coating compositions for applications such as roof coatings and paints are known in the art. For example, roof coating and paint formulations can include polymers commercially available under the trade name ACRONAL® (available from BASF), JONCRYL® (available from BASF), RHOPLEX® (available from The Dow Chemical Company), ROVACE® (available from The Dow Chemical Company), and EVOQUE® (available from The Dow Chemical Company).

In some embodiments, the first polymer and the second polymer (when present) can be dispersed in an aqueous medium to form an aqueous dispersion. The aqueous dispersion can be used to form the first coating component. The first coating component can further include a filler, a pigment, a dispersing agent, a thickener, a defoamer, a wetting agent, an adhesion promoter, a surfactant, a biocide, a coalescing agent, a flame retardant, a stabilizer, a curing agent, a flow agent, a leveling agent, a hardener, or a combination thereof.

In some embodiments, the first coating component includes at least one filler such as a pigment or extender. The term “pigment” as used herein includes compounds that provide color or opacity to the coating component. Examples of suitable pigments include metal oxides, such as titanium dioxide, zinc oxide, iron oxide, or combinations thereof. The at least one pigment can be selected from the group consisting of TiO₂ (in both anastase and rutile forms), clay (aluminum silicate), CaCO₃ (in both ground and precipitated forms), aluminum oxide, silicon dioxide, magnesium oxide, talc (magnesium silicate), barytes (barium sulfate), zinc oxide, zinc sulfite, sodium oxide, potassium oxide and mixtures thereof. Examples of commercially titanium dioxide pigments are KRONOS® 2101, KRONOS® 2310, available from Kronos WorldWide, Inc., TI-PURE® R-900, available from DuPont, or TIONA® AT1 commercially available from Millennium Inorganic Chemicals. Titanium dioxide is also available in concentrated dispersion form. An example of a titanium dioxide dispersion is KRONOS® 4311, also available from Kronos WorldWide, Inc. Suitable pigment blends of metal oxides are sold under the marks Minex® (oxides of silicon, aluminum, sodium and potassium commercially available from Unimin Specialty Minerals), Celite® (aluminum oxide and silicon dioxide commercially available from Celite Company), and Atomite® (commercially available from Imerys Performance Minerals). Exemplary fillers also include aluminum silicate (e.g., clays such as attapulgite clays, halloysite clays, and kaolin clays including those sold under the Attagel® and Ansilex® marks (commercially available from BASF Corporation)). Additional fillers include nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), mica (hydrous aluminum potassium silicate), pyrophyllite (aluminum silicate hydroxide), perlite, baryte (barium sulfate), Wollastonite (calcium metasilicate), and combinations thereof. More preferably, the filler includes TiO₂, CaCO₃, and/or a clay.

Generally, the mean particle size of the filler is 0.2 microns or greater, 1 micron or greater, 3 microns or greater, 5 microns or greater, 10 microns or greater, such as from 1 micron to 50 microns, 3 microns to 50 microns, 3 microns to 10 microns, 10 microns to 50 microns, 10 microns to 25 microns, or from 10 microns to 15 microns. For example, calcium carbonate particles used in the aqueous coating composition typically have a mean particle size of 10 microns or greater, such as from 10 microns to 15 microns. The filler can be added to the aqueous coating component as a powder or in slurry form. The filler is preferably present in the aqueous coating component in an amount from about 5 to about 70 percent by weight, preferably from 10 to 70 percent by weight, more preferably from 10 to 50 percent by weight or from 10 to 40 percent by weight (i.e. the weight percentage of the filler based on the total weight of the coating component).

In some embodiments, the first coating component can further include a functional filler. The term “functional filler” as used herein refers to a material that improves one or more properties of the coating composition. Such properties can include one or more chemical or physical property of the coating, specifically the function, utility, performance characteristics, or applicability of the coating compositions. The mean particle size of the functional filler can be 3 microns or less, such as 2.5 microns or less, 2 microns or less, 1.5 microns or less, 1.2 microns or less, 1 micron or less, 0.8 microns or less, 0.7 microns or less, or 0.6 microns or less. The mean particle sizes of the functional filler can be 0.1 microns or greater, 0.2 microns or greater, 0.3 microns or greater, 0.4 microns or greater, 0.5 microns or greater, 0.6 microns or greater, 0.7 microns or greater, 0.8 microns or greater, 0.9 microns or greater, or 1 micron or greater, In some examples, the mean particle size of the functional filler can be from 0.2 microns to 3 microns, from 0.2 microns to 2 microns, from 0.2 microns to 1.5 microns, from 0.2 microns to 1 micron, from 0.2 microns to 0.8 microns, from 0.2 microns to 0.7 microns, from 0.3 microns to 3 microns, from 0.3 microns to 2 microns, from 0.3 microns to 1.5 microns, from 0.3 microns to 1 microns, from 0.3 microns to 0.8 microns, or from 0.3 microns to 0.6 microns. Examples of suitable functional fillers include barium sulfate, calcium carbonate, kaolin, halloysite, or a combination thereof.

The functional filler can include a mixture of two or more fillers, such as a mixture of barium sulfate and kaolin, a mixture of barium sulfate and halloysite, a mixture of calcium carbonate and kaolin, a mixture of calcium carbonate and halloysite, a mixture of kaolin and halloysite, or a mixture of barium sulfate and calcium carbonate. The two or more functional fillers can be in a weight ratio from 1:20 to 20:1, from 1:10 to 10:1, from 1:10 to 1:1, from 1:8 to 1:2, from 1:5 to 5:1, or from 1:4 to 4:1.

The functional filler can be present in the first coating component in an amount of at least 5% by weight (e.g., at least 10% by weight, at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, or at least 70% by weight), based on the weight of the first coating component. In some embodiments, the functional filler can be present in the first coating component in an amount of 70% or less by weight (e.g., 65% or less by weight, 60% or less by weight, 55% or less by weight, 50% or less by weight, 45% or less by weight, 40% or less by weight, 35% or less by weight, 30% or less by weight, 25% or less by weight, or 20% or less by weight), based on the weight of the first coating component. The functional filler can be present in the first coating component in an amount ranging from any of the minimum values described above to any of the maximum values described above. For example, the functional filler can be present in the first coating component in an amount of 10%-70% by weight (e.g., 10%-60%, 10%-50%, 15%-40%, 20%-60%, 20%-50% or 20%-40% by weight), based on the weight of the first coating component.

In some instances, the functional filler can be the only filler present in the coating compositions. In other instances, the coating compositions do not include a functional filler. In further instances, the coating compositions include both the functional filler and an additional filler such as the fillers described herein. For example, the functional filler can be used to replace a portion of the conventional calcium carbonate filler present in the coating compositions. The functional filler and the additional filler (such as calcium carbonate) can in in a weight ratio from 1:20 to 20:1, from 1:10 to 10:1, from 1:10 to 1:1, from 1:8 to 1:2, from 1:5 to 5:1, or from 1:4 to 4:1. The functional filler and the additional filler can be present in the first coating component in an amount of 10%-70% by weight (e.g., 10%-60%, 10%-50%, 15%-40%, 20%-60%, 20%-50% or 20%-40% by weight), based on the weight of the first coating component.

In addition to the polymer and filler, the first coating component can further comprise a thickener. The thickener can include an alkali swellable thickener such as a hydrophobically modified alkali swellable emulsion (HASE) copolymer, more specifically, an anionic, hydrophobically modified alkali swellable emulsion polyacrylate copolymer. Examples of other suitable thickeners include non-ionic associative thickeners, hydrophobically modified ethylene oxide urethane (HEUR) polymers, cellulosic thickeners such as hydrophobically modified hydroxyethyl celluloses (HMHECs), hydrophobically modified polyacrylamide, attapulgite clays, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener. The thickener can be present in an amount from greater than 0% to 5% by weight, from 0.15% to 2.5% by weight, or from 0.15% to 0.5% by weight, based on the weight of the first coating component.

The coating compositions may include a pigment dispensing agent. Examples of suitable pigment dispersing agents are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a polyacrylic acid-type dispersing agent, such as Pigment Disperser N, commercially available from BASF SE.

Defoamers serve to minimize frothing during mixing and/or application of the coating component. Suitable defoamers include organic defoamers such as mineral oils, silicone oils, and silica-based defoamers. Exemplary silicone oils include polysiloxanes, polydimethylsiloxanes, polyether modified polysiloxanes, and combinations thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

Suitable surfactants include nonionic surfactants and anionic surfactants. Examples of nonionic surfactants are alkylphenoxy polyethoxyethanols having alkyl groups of about 7 to about 18 carbon atoms and having from about 6 to about 60 oxyethylene units; ethylene oxide derivatives of long chain carboxylic acids; analogous ethylene oxide condensates of long chain alcohols, and combinations thereof. Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical.

Other suitable additives that can optionally be incorporated into the first coating component include coalescing agents (coalescents), pH modifying agents, biocides, co-solvents and plasticizers, crosslinking agents (e.g., quick-setting additives, for example, a polyamine such as polyethyleneimine), dispersing agents, rheology modifiers, wetting and spreading agents, leveling agents, conductivity additives, adhesion promoters, anti-blocking agents, anti-cratering agents and anti-crawling agents, anti-freezing agents, corrosion inhibitors, anti-static agents, flame retardants and intumescent additives, dyes, optical brighteners and fluorescent additives, UV absorbers and light stabilizers, chelating agents, cleanability additives, flatting agents, humectants, insecticides, lubricants, odorants, oils, waxes and slip aids, soil repellants, stain resisting agents, and combinations thereof.

Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether (PnB, including those sold under the tradename DOWANOL®), dipropylene glycol n-butyl ether (DPnB, including those sold under the tradename DOWANOL®), 2,2,4-trimethyl-1,3-pentanediol monoisobutyrate, and combinations thereof.

Examples of suitable pH modifying agents include bases such as sodium hydroxide, potassium hydroxide, amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof.

Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-l-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OIT), 4,5-dichloro-2-n-octyl-3-isothiazolone, as well as acceptable salts and combinations thereof. Suitable biocides also include biocides that inhibit the growth of mold, mildew, and spores thereof in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc. The biocide can alternatively be applied as a film to the coating and a commercially available film-forming biocide is Zinc Omadine® commercially available from Arch Chemicals, Inc.

Exemplary co-solvents and humectants include ethylene glycol, propylene glycol, diethylene glycol, and combinations thereof.

As described herein, exemplary crosslinking agents include dihydrazides (e.g., dihydrazides of adipic acid, succinic acid, oxalic acid, glutamic acid, or sebastic acid), diacetone acrylamide (DAAM), a monomer comprising 1,3-diketo groups, a silane crosslinker, or a combination thereof. The dihydrazides can be used, for example, to crosslink diacetone acrylamide or other crosslinkable monomers.

An antioxidant can be added to polymers derived from styrene and butadiene to prevent oxidation of the double bonds of the polymer and can either be added before or after vulcanization of the polymer. The antioxidants can be, for example, substituted phenols or secondary aromatic amines. Antiozonants can also be added to polymers derived from styrene and butadiene to prevent ozone present in the atmosphere from cracking the polymer by cleaving the double bonds in the polymer. Prevulcanization inhibitors can also be added to polymers derived from styrene and butadiene to prevent premature vulcanization or scorching of the polymer.

If desired, polymers derived from styrene and butadiene can be vulcanized or cured to crosslink the polymer thereby increasing the tensile strength and elongation of the rubber by heating the polymer, typically in the presence of vulcanizing agents, vulcanization accelerators, antireversion agents, and optionally crosslinking agents. Exemplary vulcanizing agents include various kinds of sulfur such as sulfur powder, precipitated sulfur, colloidal sulfur, insoluble sulfur and high-dispersible sulfur; sulfur halides such as sulfur monochloride and sulfur dichloride; sulfur donors such as 4,4′-dithiodimorpholine; selenium; tellurium; organic peroxides such as dicumyl peroxide and di-tert-butyl peroxide; quinone dioximes such as p-quinone dioxime and p,p′-dibenzoylquinone dioxime; organic polyamine compounds such as triethylenetetramine, hexamethylenediamine carbamate, 4,4′-methylenebis(cyclohexylamine) carbamate and 4,4′-methylenebis-o-chloroaniline; alkylphenol resins having a methylol group; and mixtures thereof. In some examples, the vulcanizing agents include sulfur dispersions or sulfur donors. The vulcanizing agent can be present from 0.1 to 15%, from 0.3 to 10%, or from 0.5 to 5%, by weight based on the weight of the polymer.

Exemplary vulcanization accelerators include sulfenamide-type vulcanization accelerators such as N-cyclohexyl-2-benzothiazole sulfenamide, N-t-butyl-2-benzothiazole sulfenamide, N-oxyethylene-2-benzothiazole sulfenamide, N-oxydiethylene-2-benzothiazole sulfenamide, N-oxydiethylene-thiocarbamyl-N-oxydiethylene sulfenamide, N-oxyethylene-2-benzothiazole sulfenamide and N,N′-diisopropyl-2-benzothiazole sulfenamide; guanidine-type vulcanization accelerators such as diphenylguanidine, di-o-tolylguanidine and di-o-tolylbiguanidine; thiourea-type vulcanization accelerators such as thiocarboanilide, di-o-tolylthiourea, ethylenethiourea, diethylenethiourea, dibutylthiourea and trimethylthiourea; thiazole-type vulcanization accelerators such as 2-mercaptobenzothiazole, dibenzothiazyl disulfide, 2-mercaptobenzothiazole zinc salt, 2-mercaptobenzothiazole sodium salt, 2-mercaptobenzothiazole cyclohexylamine salt, 4-morpholinyl-2-benzothiazole disulfide and 2-(2,4-dinitrophenylthio)benzothiazole; thiadiazine-type vulcanization accelerators such as activated thiadiazine; thiuram-type vulcanization accelerators such as tetramethylthiuram monosulfide, tetramethylthiuram disulfide, tetraethylthiuram disulfide, tetrabutylthiuram disulfide and dipentamethylenethiuram tetrasulfide; dithiocarbamic acid-type vulcanization accelerators such as sodium dimethyldithiocarbamate, sodium diethyldithiocarbamate, sodium di-n-butyldithiocarbamate, lead dimethyldithiocarbamate, lead diamyldithiocarbamate, zinc diamyldithiocarbamate, zinc dimethyldithiocarbamate, zinc diethyldithiocarbamate, zinc di-n-butyldithiocarbamate, zinc pentamethylene dithiocarbamate, zinc ethylphenyldithiocarbamate, tellurium diethyldithiocarbamate, bismuth dimethyldithiocarbamate, selenium dimethyldithiocarbamate, selenium diethyldithiocarbamate, cadmium diethyldithiocarbamate, copper dimethyldithiocarbamate, iron dimethyldithiocarbamate, diethylamine diethyldithiocarbamate, piperidinium pentamethylene dithiocarbamate and pipecoline pentamethylene dithiocarbamate; xanthogenic acid-type vulcanization accelerators such as sodium isopropylxanthogenate, zinc isopropylxanthogenate and zinc butylxanthogenate; isophthalate-type vulcanization accelerators such as dimethylammonium hydrogen isophthalate; aldehyde amine-type vulcanization accelerators such as butyraldehyde-amine condensation products and butyraldehyde-monobutylamine condensation products; and mixtures thereof. The vulcanization accelerator can be present within a range of from 0.1 to 15%, from 0.3 to 10%, or from 0.5 to 5%, by weight based on the weight of the polymer.

Antireversion agents can also be included in the vulcanization system to prevent reversion, i.e., an undesirable decrease in crosslink density. Suitable antireversion agents include zinc salts of aliphatic carboxylic acids, zinc salts of monocyclic aromatic acids, bismaleimides, biscitraconimides, bisitaconimides, aryl bis-citraconamic acids, bissuccinimides, and polymeric bissuccinimide polysulfides (e.g., N,N′-xylenedicitraconamides). The antireversion agent can be present in a range of from 0 to 5%, from 0.1 to 3%, or from 0.1 to 2% by weight based on the weight of the polymer.

In addition to the above components, the first coating component can include water to form an aqueous dispersion. The water can be present in an amount of from 10% to 60% by weight of the first coating component. For example, the water can be present in an amount of from 20% to 50% by weight, from 20% to 40% of from 25% to 40% by weight of the first coating component.

In some embodiments, the first coating component can include the following components (based on total weight of the first coating component): water 10-50% by weight, propylene glycol 0.5-2.5% by weight, pigment dispersing agent 0.4-0.85% by weight, one or more polymer dispersions (at 55-65% by weight polymer(s)) 35-60% by weight, plasticizer 0-1.0% by weight, defoamer 0.3-1.4% by weight, non-ionic surfactant 0-0.1% by weight, thickener 0.1-0.4% by weight, titanium dioxide 3.0-11.2% by weight, calcium carbonate 25-35% by weight, talc or kaolin 0-20% by weight, functional filler greater than 0%-45% by weight, biocide 0.1-0.3% by weight, and ammonia 0.1-0.3% by weight.

The volume solids percentage of the first coating component can be at least 40%. For example, the volume solids percentage of the first coating component can at least 45%, at least 50%, at least 55%, at least 60%, at least 65%, at least 70%, or at least 75%.

The weight solids percentage of the first coating component can be at least 50%. For example, the weight solids percentage of the first coating component can be at least 55%, at least 60%, at least 65%, at least 70%, at least 75%, or at least 80%.

The compositions disclosed herein may include a second coating component. The second coating component can comprise a catalyst. The catalyst can function to decrease the stability of the dispersion of one or more polymers in the first coating component, causing the coating to set more quickly. The catalyst may also act as a flocculant that precipitate solids or semi-solids from solution, such as polymeric particles from a latex dispersion, or impurities from water. The catalyst may further act as a film forming agent, that enhances film formation of the coating composition. In some embodiments, the catalyst can include charged polymers (see, for example, U.S. Pat. No. 5,219,914 to Warburton which is incorporated by reference herein in its entirety) and multivalent metal salts, including suitable zinc, iron, calcium, and aluminum salts (see, for example, U.S. Pat. No. 3,823,024 to Cogliano, U.S. Pat. No. 4,386,992 to Kunishiga, et al., U.S. Pat. No. 4,571,415 to Jordan, and U.S. Pat. No. 5,403,393 to Dubble, U.S. Patent Application Publication No. 2004/0000329 to Albu, et al., as well as U.S. Patent Application Publication No. 2017/0037263 to Iyer, et al., all of which are incorporated by reference herein in their entirety). Exemplary catalyst includes phosphoric acid, formic acid, polyaluminum chloride, polyvinyl amine having a molecular weight from about 3,000 Da to about 35,000 Da, aluminum sulfate, or a mixture thereof.

In some examples, the catalyst in the second component includes phosphoric acid. the phosphoric acid catalyst can be selected from H₃PO₄, a polyphosphoric acid compound represented by the formula, Hₙ₊₂PₙO₃ₙ₊₁, wherein n is an integer from 2 to 30, or a combination thereof.

The catalyst (e.g., the phosphoric acid catalyst) can be present in an amount of at least 0.03% by weight (e.g., at least 0.05% by weight, at least 0.1% by weight, at least 0.2% by weight, at least 0.3% by weight, at least 0.4% by weight, at least 0.5% by weight, at least 0.6% by weight, at least 0.7% by weight, at least 0.8% by weight, at least 0.9% by weight, at least 1.0% by weight, at least 1.5% by weight, at least 2.0% by weight, at least 2.5% by weight, at least 3.0% by weight, at least 4.0% by weight, at least 5.0% by weight, at least 6.0% by weight, at least 7.0% by weight, at least 10.0% by weight, or at least 15% by weight), based on the weight of the aqueous coating composition. In some embodiments, the catalyst (e.g., the phosphoric acid catalyst) can be present in an amount of 15% or less by weight (e.g., 14% or less by weight, 13% or less by weight, 12% or less by weight, 11% or less by weight, 10% or less by weight, 9.0% or less by weight, 8.0% or less by weight, 7.0% or less by weight, 6.0% or less by weight, 5.0% or less by weight, less than 5.0% by weight, 4.5% or less by weight, 4.0% or less by weight, 3.5% or less by weight, 3.0% or less by weight, 2.5% or less by weight, 2.0% or less by weight, 1.5% or less by weight, 1.0% or less by weight, 0.9% or less by weight, 0.8% or less by weight, 0.7% or less by weight, 0.6% or less by weight, 0.7% or less by weight, 0.6% or less by weight, 0.5% or less by weight, 0.4% or less by weight, 0.3% or less by weight, or 0.2% or less by weight), based on the weight of the aqueous coating composition. The catalyst (e.g., the phosphoric acid catalyst) can be present in an amount ranging from any of the minimum values described above to any of the maximum values described above. For example, the catalyst (e.g., the phosphoric acid catalyst) can be present in an amount of 0.03%-15% by weight (e.g., 0.03%-10%, 0.03%-7.5%, 0.03%-less than 5%, 0.03%-4%, 0.03%-3.5%, 0.05%-10%, 0.05%-7.5% or 0.05%-less than 5%, 0.05%-4%, 0.05%-3.5% by weight), based on the weight of the aqueous coating composition.

The second coating component can comprise an effective amount of the catalyst, such that when the second coating component is combined with the first coating component, the addition of the catalyst decreases the stability of the dispersion of one or more polymers in the first coating component, causing the coating to set more quickly.

The first coating component and the second coating component can be provided as separate aqueous compositions (e.g., in a kit as the first and second components of two-part aqueous coating composition). The first coating component and the second coating component that can be co-applied (e.g., simultaneously or sequentially) to a substrate (e.g., as a film) and allowed to dry to form a dried coating. Alternately, the first coating component can be applied alone to produces a coating on the surface. For example, a first coating component comprising the first polymer, a functional filler, and an additional filler can be applied to a surface and form a coating.

Generally, coatings are formed by applying the first coating component and the second coating component of the two-part aqueous coating compositions as described herein to a surface and allowing the coating to dry to form a dried coating. The surface can be, for example, metal, asphalt, wet or dry concrete, stone, ceramic, wood, plastic, polyurethane foam, glass, masonry or cinder block, stucco, manufactured (or engineered) board (e.g., cement board, gypsum board, expanded polystyrene (EPS) board, an oriented strand board (OSB)), or another coating layer applied on such a surface. Specific examples of surfaces include PVC pipe, concrete, brick, mortar, asphalt, a granulated asphaltic cap sheet, carpet, a granule, pavement, a ceiling tile, a sport surface, an exterior insulation and finish system (EIFS), a vehicle, a spray polyurethane foam surface (including those made with silicone surfactants), a metal, a thermoplastic polyolefin surface, an ethylene-propylene diene monomer (EPDM) surface, a modified bitumen surface, a roof, a wall, a storage tank, and another coating surface (in the case of recoating applications). In some embodiments, the surface can be an architectural surface. In some embodiments, the surface can be a substantially horizontal surface such as a roof surface. In some embodiments, the surface can be a substantially vertical surface such as a wall. In some embodiments, the coating composition can be applied to floors to provide moisture control to provide crack-bridging properties.

The first coating component can be applied to a surface by any suitable coating technique, including spraying, rolling, brushing, or spreading. The first coating component and the second coating component can be applied to a surface by spraying. The first coating component and/or the second coating component can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating. The first coating component can be applied in combination with the second coating composition to form a rapid set coating. The second coating component can be applied to a surface prior to applying the first coating component, applied to a surface simultaneously with the first coating component, or applied to a coating of the first coating component after it has been applied to a surface but prior to drying.

In certain embodiments, the first coating component and the second coating component are simultaneously applied to the surface to be coated (e.g., to an architectural surface such as a roof or wall). For example, the first coating component and the second coating component can be sprayed as converging or overlapping streams which mix as they are applied to the surface. In these embodiments, the first coating component and the second coating component can be simultaneously applied using a machine configured to spray both the first coating component (e.g., a polymer dispersion) and the second coating component (e.g., a catalyst) on to a surface such that the spraying areas overlap. Suitable machines include application systems which include two separate spray guns regulated such that the spraying areas of the two separate spray guns overlap, as well as application systems which include a single spray gun having two separate spray nozzles having overlapping spraying areas (e.g., spray guns configured for external mixing available from Binks Manufacturing Co., Franklin Park, Ill.). Alternatively, the first coating component and the second coating component can be simultaneously applied using a single sprayer configured to internally mix the first coating component and the second coating component prior to application.

In certain embodiments, the first coating component and the second coating component are simultaneously applied to a surface using a spray system which includes a single spray gun having first and second nozzles, a first pump fluidly connected between the first nozzle and a first solution reservoir for delivering the first coating component to the first nozzle at a first fluid pressure, and a second pump fluidly connected between the second nozzle and a second solution reservoir for delivering the second coating component to the second nozzle at a second fluid pressure.

The viscosity of the first coating component can be measured using a Stormer viscometer and is expressed as Krebs Units (KU). In some embodiments, the first coating component can be applied at a viscosity of at least 50 KU (e.g., at least 55 KU, at least 60 KU, at least 65 KU, at least 70 KU, at least 75 KU, at least 80 KU, at least 85 KU, at least 90 KU, at least 95 KU, at least 100 KU, at least 105 KU, at least 110 KU, at least 115 KU, or at least 120 KU) measured using a Stormer viscometer. In some embodiments, the first coating component can be applied at a viscosity of 120 KU or less (e.g., 110 KU or less, 100 KU or less, 95 KU or less, 90 KU or less, 85 KU or less, 80 KU or less, 75 KU or less, 70 KU or less, 65 KU or less, 60 KU or less, 55 KU or less, 50 KU or less, or 45 KU or less) measured using a Stormer viscometer. The first coating component can be applied at a viscosity ranging from any of the minimum values described above to any of the maximum values described above. For example, in some embodiments, the first coating component can be applied at a viscosity of from 40 KU to 120 KU, from 40 KU to 110 KU, from 40 KU to 100 KU, from 50 KU to 120 KU, from 50 KU to 100 KU, measured using a Stormer viscometer.

In some embodiments, the first coating component can be applied at a viscosity of at least 50 cP (e.g., at least 100 cP, at least 500 cP, at least 1,000 cP, at least 2,000 cP, at least 5,000 cP, at least 10,000 cP, at least 12,000 cP, at least 15,000 cP, at least 20,000 cP, at least 25,000 cP, at least 30,000 cP, or at least 35,000 cP) measured using a Brookfield RV viscometer with spindle #3 at 2 rpm at 20° C. In some embodiments, the first coating component can be applied at a viscosity of 40,000 cP or less (e.g., 35,000 cP or less, 30,000 cP or less, 25,000 cP or less, 20,000 cP or less, 15,000 cP or less, 12,000 cP or less, 10,000 cP or less, 5,000 cP or less, 2,000 cP or less, 1,000 cP or less, 500 cP or less, or 100 cP or less) measured using a Brookfield RV viscometer with spindle #3 at 2 rpm at 20° C. The first coating component can be applied at a viscosity ranging from any of the minimum values described above to any of the maximum values described above. For example, in some embodiments, the first coating component can be applied at a viscosity of from 50 cP to 40,000 cP measured using a Brookfield RV viscometer with spindle #3 at 2 rpm at 20° C. In some embodiments, the first coating component can have a viscosity of from 500 to 30,000 cP, from 1,000 to 12,000 cP, from 2,000 to 12,000 cP, from 2,000 to 8,000 cP, or from 2,000 to 5,000 cP.

In some embodiments, the first coating component can be applied (such as by spraying) at a pressure of greater than 300 psi (e.g., at least 350 psi, at least 400 psi, at least 450 psi, at least 500 psi, at least 550 psi, at least 600 psi, at least 650 psi, at least 700 psi, at least 750 psi, at least 800 psi, at least 850 psi, at least 900 psi, at least 950 psi, at least 1,000 psi, at least 1,050 psi, at least 1,100 psi, at least 1,150 psi, at least 1,200 psi, at least 1,250 psi, at least 1,300 psi, at least 1,350 psi, at least 1,400 psi, at least 1,450 psi, or at least 1,500 psi). In some embodiments, the first coating component can be applied at a pressure of 2,500 psi or less (e.g., 2,000 psi or less, 1,800 psi or less, 1,500 psi or less, 1,450 psi or less, 1,400 psi or less, 1,350 psi or less, 1,300 psi or less, 1,250 psi or less, 1,200 psi or less, 1,150 psi or less, 1,100 psi or less, 1,050 psi or less, 1,000 psi or less, 950 psi or less, 900 psi or less, 850 psi or less, 800 psi or less, 750 psi or less, 700 psi or less, 650 psi or less, 600 psi or less, 500 psi or less, 450 psi or less, or 400 psi or less). The first coating component can be applied at a pressure ranging from any of the minimum values described above to any of the maximum values described above. For example, in some embodiments, the first coating component can be and can be applied at a pressure of from greater than 300 psi to 2,500 psi or from greater than 300 psi to 1,500 psi. In some embodiments, the first coating component can be and can be applied at a pressure of from 800 psi to 2,500 psi, from 350 psi to 1,500 psi, from 400 psi to 1,500 psi, from 500 psi to 1,500 psi, from 500 psi to 1,200 psi, or from 900 psi to 1,200 psi.

In some embodiments, the second coating component can be applied (such as by spraying) at a pressure of 30 psi or greater (e.g., at least 35 psi, at least 40 psi, at least 45 psi, at least 50 psi, at least 55 psi, at least 60 psi, at least 65 psi, at least 70 psi, at least 75 psi, at least 80 psi, at least 85 psi, at least 90 psi, at least 95 psi, at least 100 psi, at least 110 psi, at least 150 psi, at least 200 psi, at least 250 psi, or at least 300 psi). In some embodiments, the second coating component can be applied at a pressure of 300 psi or less (e.g., 250 psi or less, 200 psi or less, 175 psi or less, 150 psi or less, 125 psi or less, 110 psi or less, 100 psi or less, 90 psi or less, 85 psi or less, 80 psi or less, 75 psi or less, 70 psi or less, 65 psi or less, 60 psi or less, 55 psi or less, 50 psi or less, 45 psi or less, 40 psi or less, 35 psi or less, or 30 psi or less). The second coating component can be applied at a pressure ranging from any of the minimum values described above to any of the maximum values described above. For example, in some embodiments, the second coating component can be and can be applied at a pressure of from 30 psi to 300 psi. In some embodiments, the second coating component can be and can be applied at a pressure of from 30 psi to 200 psi, from 30 psi to 150 psi, from 40 psi to 200 psi, from 50 psi to 200 psi, or from 50 psi to 150 psi.

The first coating component can be applied at a rate of greater than 1.7 gallons/minute, from 1.7 to 4 gallons/minute, or from 2.5 to 4 gallons/minute onto the surface. The second coating component can be applied at a rate from 0.01 to 2.0 gallons/minute onto the surface. The aqueous coating composition can be applied at a rate of greater than 1.7 gallons/minute, from 1.7 to 4 gallons/minute, or from 2.5 to 4 gallons/minute onto the surface.

The thickness of the resultant coatings can vary depending upon the application of the coating. For example, the coating can have a dry thickness of at least 10 mils (e.g., at least 15 mils, at least 20 mils, at least 25 mils, at least 30 mils, or at least 40 mils). In some instances, the coating has a dry thickness of less than 100 mils (e.g., less than 90 mils, less than 80 mils, less than 75 mils, less than 60 mils, less than 50 mils, less than 40 mils, less than 35 mils, or less than 30 mils). In some embodiments, the coating has a dry thickness of between 10 mils and 100 mils. In certain embodiments, the coating has a dry thickness of between 10 mils and 40 mils.

The first coating component and the second coating component can be applied as a film, dried, subjected to an accelerated weathering process to simulate extended field exposure for 1000 hours or more, and then subjected to the mandrel bend test set forth in ASTM D 6083-05 at −26° C. (or −18° C.). In some embodiments, the first coating component and the second coating component described herein when applied in combinations as a film, dried and weathered passes the mandrel bend test set forth in ASTM D 6083-05 at −26° C. In some embodiments, the first coating component and the second coating component described herein when applied in combinations as a film, dried and weathered passes the mandrel bend test set forth in ASTM D 6083-05 at −18° C.

The elongation at break of the coatings formed from the first coating component and the second coating component described herein can be measured according to ASTM D-2370. Generally, the coatings display an elongation at break after a drying period of at least 14 days, as measured according to ASTM D-2370 of at least 90% (e.g., at least 95%, at least 100%, at least 110%, at least 120%, at least 130%, at least 140%, at least 150%, at least 160%, at least 170%, at least 180%, at least 190%, or at least 200%). In some embodiments, the coatings display an elongation at break after 1,000 of accelerated weathering, as measured according to ASTM D-2370 of at least 90% (e.g., at least 95%, at least 100%, at least 110%, at least 120%, at least 130%, at least 140%, at least 150%, at least 160%, at least 170%, at least 180%, at least 190%, or at least 200%).

The tensile strength of coatings formed from the first coating component and the second coating component described herein can be measured according to ASTM D-2370. Generally, the coatings display tensile after a drying period of at least 14 days, as measured according to ASTM D-2370 of at least 140 psi (e.g., at least 150 psi, at least 160 psi, at least 170 psi, at least 180 psi, at least 190 psi, at least 200 psi, at least 210 psi, at least 220 psi, or at least 225 psi). In some embodiments, the coatings display tensile strength after 1,000 of accelerated weathering, as measured according to ASTM D-2370 of at least 140 psi (e.g., at least 150 psi, at least 160 psi, at least 170 psi, at least 180 psi, at least 190 psi, at least 200 psi, at least 210 psi, at least 220 psi, or at least 225 psi)

In certain embodiments, the coating formed from the first coating component and the second coating component is an elastomeric roof coating. In certain embodiments, the coating will generally satisfy the requirements of ASTM D6083-05, entitled “Standard Specification for Liquid Applied Acrylic Coating Used in Roofing”. In particular embodiments, a sprayed film derived from the coating compositions, such as a first polymer selected from an acrylic homopolymer or an acrylic copolymer; a filler, and a phosphoric acid catalyst, passes the Standard Specification for Liquid Applied Acrylic Coating test set forth in ASTM D 6083-97. In certain embodiments, the sprayed film has a tensile strength of greater than 200 psi (e.g., from greater than 200 psi to 300 psi, or from greater than 200 psi to 250 psi), and an elongation at break of greater than 100% (e.g., greater than 140%, or from greater than 100% to 180%), according to ASTM D-2370. In certain embodiments, the sprayed film has a tensile strength of greater than 200 psi (e.g., from greater than 200 psi to 300 psi, or from greater than 200 psi to 250 psi), and an elongation at break of greater than 100% (e.g., greater than 140%, or from greater than 100% to 180%), according to ASTM D-2370, after 1,000 hours of accelerated weathering at 23° C.

In other embodiments, the coating formed from the first coating component and the second coating component is an architectural coating or an industrial coating.

In some embodiments, the coating formed from the first coating component and the second coating component is a barrier coating. The barrier coating when dried, can exhibit barrier properties to air, vapor such as water vapor, or liquid water. In some embodiments, the barrier coating comprises a) from 20% to 85% by weight of a first polymer, based on the dry weight in the barrier composition, b) from 10% to 70% (e.g., from 10%-50% by weight, or from 15% to 40% by weight) by weight of a filler, based on the dry weight in the barrier composition, c) a phosphoric acid catalyst, and d) one or more additives selected from a coalescent agent, a pigment dispersant, a defoamer, a wetting agent, an adhesion promoter, or a combination. The first polymer can be derived from an acrylic homopolymer, an acrylic-based copolymer, a styrene-acrylic-based copolymer, a vinyl acrylic-based copolymer, an ethylene vinyl acetate-based copolymer, a polyurethane resin, or a combination thereof. The barrier coatings can further comprise a functional filler selected from kaolin, halloysite, barium sulfate, calcium carbonate, or a mixture thereof, wherein the functional filler has an average particle size diameter of 3 microns or less, as determined by Sedigraph 5100 Particle Size Analyzer.

The barrier coatings after spraying and drying, can exhibit a vapor permeability of greater than 0.1 US perms, greater than 0.5 US perms, greater than 1 US perms, greater than 1.5 US perms, greater than 2 US perm, up to 10 US perms. The barrier coatings after spraying and drying, can exhibit a tensile strength of 100 psi or greater (e.g., from 100 psi to 300 psi, from 100 psi to 250 psi, or from 200 psi to 250 psi), according to ASTM D-2370. The barrier coating can be provided as a coating on metal, asphalt, wet or dry concrete, stone, ceramic, wood, plastic, polyurethane foam, glass, masonry or cinder blocks, stucco, manufactured board (e.g., cement board, gypsum board, expanded polystyrene (EPS) board, an oriented strand board (OSB)), or another coating layer applied on a substrate. The surface can be a roof or a wall surface.

In some embodiments, the coating formed from the first coating component and the second coating component is an intumescent coating. Intumescent coatings are described in WO 2019/099372, which is hereby incorporated by reference in its entirety. The intumescent coatings can include a first coating component comprising a first polymer and optionally a second polymer; a second coating component comprising a catalyst; and an additive comprising an intumescent agent, a vibration damping agent, an insulation agent, or a combination of two or more thereof. The additive can be present in the first coating component, the second coating component, or both the first and second coating components. The intumescent agent can comprise an acid source, a carbon source, and a gas forming agent; the vibration damping agent can comprise a first filler; and the insulation agent can comprise a second filler.

In some embodiments, the acid source in the intumescent agent can include melamine phosphate, magnesium phosphate, boric acid and ammonium poly -phosphate, polyphosphoric acid, or a combination of any two or more thereof. The acid source can be present in an amount of about 5 wt % to about 40 wt %, based on a total weight of the composition. In some embodiments, the acid source can be present at about 15 wt % to about 40 wt %, about 15 wt % to about 35 wt %, about 15 wt % to about 30 wt %, or about 15 wt % to about 25 wt %, based on a total weight of the composition.

The carbon source can be a compound, a salt, a complex, or composition capable of generating or decomposing or intumescing into char at an elevated temperature. In some embodiments, the carbon source can include a mono- or poly-substituted long chain hydrocarbon. For example, the carbon source may include a mono- or poly-substituted C₄-C₂₀ hydrocarbon chain including mono- or poly-substituted C₅-C₁₂ hydrocarbon chains. In some examples, the carbon source can include pentaerythritol, dipentaerythritol, tripentaerythritol, starch, polyol compounds, sugars, expanding graphite, cellulose acetate, or a combination of any two or more thereof. The carbon source can be present in an amount from about 1 wt % to about 40 wt %, based on a total weight of the composition. In some embodiments, the carbon source can be present in an amount from about 4 wt % to about 40 wt %, about 4 wt % to about 35 wt %, about 4 wt % to about 30 wt %, or about 4 wt % to about 25 wt %, based on a total weight of the composition.

The gas forming agent can include melamine, melamine derivative, a nitrogenous derivative, a phosphorus-containing derivative, or a combination of any two or more thereof. The melamine derivative can be a salt. In some examples, the gas forming agent can include melamine, melamine cyanurate, melamine borate, melamine phosphate, tris-(hydroxy ethyl) isocyanurate, melamine polyphosphate, chlorinated paraffin, or a combination of any two or more thereof. The gas forming agent can be present in an amount from about 1 wt % to about 40 wt %, about 5 wt % to about 40 wt %, about 5 wt % to about 35 wt %, about 5 wt % to about 30 wt %, about 5 wt % to about 25 wt %, or about 5 wt % to about 20 wt %, based on a total weight of the composition.

The intumescent coating composition can exhibit a thermal conductivity as measured according to ASTM C-518 of from about 0.020 N/mK to about 0.065 N/mK including about 0.040 N/mK to about 0.062 N/mK or about 0.050 N/mK to about 0.059 N/mK.

The sprayed film exhibits low water absorption after drying. In some embodiments, the sprayed film after drying for 14 days, has a water absorption after 7 days soaking in water, of less than 15% by weight, less than 10% by weight, or less than 8% by weight, based on the weight of the sprayed film.

### Methods

The first polymer and the second polymer (when present) can be prepared by polymerizing the monomers using free-radical emulsion polymerization. The monomers for the first polymer and the second polymer (when present) can be prepared as aqueous dispersions. The emulsion polymerization temperature is generally from 10° C. to 95° C., from 30° C. to 95° C., or from 75° C. to 90° C. The polymerization medium can include water alone or a mixture of water and water-miscible liquids, such as methanol. In some embodiments, water is used alone. The emulsion polymerization can be carried out either as a batch, semi-batch, or continuous process. Typically, a semi-batch process is used. In some embodiments, a portion of the monomers can be heated to the polymerization temperature and partially polymerized, and the remainder of the polymerization batch can be subsequently fed to the polymerization zone continuously, in steps or with superposition of a concentration gradient.

The free-radical emulsion polymerization can be carried out in the presence of a free-radical polymerization initiator. The free-radical polymerization initiators that can be used in the process are all those which are capable of initiating a free-radical aqueous emulsion polymerization including alkali metal peroxydisulfates and H₂O₂, or azo compounds. Combined systems can also be used comprising at least one organic reducing agent and at least one peroxide and/or hydroperoxide, e.g., tert-butyl hydroperoxide and the sodium metal salt of hydroxymethanesulfinic acid or hydrogen peroxide and ascorbic acid. Combined systems can also be used additionally containing a small amount of a metal compound which is soluble in the polymerization medium and whose metallic component can exist in more than one oxidation state, e.g., ascorbic acid/iron(II) sulfate/hydrogen peroxide, where ascorbic acid can be replaced by the sodium metal salt of hydroxymethanesulfinic acid, sodium sulfite, sodium hydrogen sulfite or sodium metal bisulfite and hydrogen peroxide can be replaced by tert-butyl hydroperoxide or alkali metal peroxydisulfates and/or ammonium peroxydisulfates. In the combined systems, the carbohydrate derived compound can also be used as the reducing component. In general, the amount of free-radical initiator systems employed can be from 0.1 to 2%, based on the total amount of the monomers to be polymerized. In some embodiments, the initiators are ammonium and/or alkali metal peroxydisulfates (e.g., sodium persulfate), alone or as a constituent of combined systems. The manner in which the free-radical initiator system is added to the polymerization reactor during the free-radical aqueous emulsion polymerization is not critical. It can either all be introduced into the polymerization reactor at the beginning, or added continuously or stepwise as it is consumed during the free-radical aqueous emulsion polymerization. In detail, this depends in a manner known to an average person skilled in the art both from the chemical nature of the initiator system and on the polymerization temperature. In some embodiments, some is introduced at the beginning and the remainder is added to the polymerization zone as it is consumed. It is also possible to carry out the free-radical aqueous emulsion polymerization under superatmospheric or reduced pressure.

The first polymer or second polymer (when present) can each independently be produced by single stage polymerization or multiple stage polymerization. In some embodiments, the first polymer and the second polymer are each polymerized separately to produce a first dispersion including a plurality of polymer particles including the first polymer and a second dispersion comprising a plurality of polymer particles including the second polymer. The first and second dispersions can then be combined to provide a dispersion including the first and second polymers. In some embodiments, the first polymer and the second polymer are provided in the same polymer particle by using multiple stage polymerization such that one of the first polymer and second polymer can be present as a first stage polymer of a multistage polymer (e.g., as a core in a core/shell polymer particle) and one of the first polymer and second polymer can be present as a second stage polymer of a multistage polymer (e.g., as a shell in a core/shell polymer particle).

One or more surfactants can be included in the aqueous dispersions to improve certain properties of the dispersions, including particle stability. For example, oleic acid, sodium laureth sulfate, and alkylbenzene sulfonic acid or sulfonate surfactants could be used. Examples of commercially available surfactants include Calfoam® ES-303, a sodium laureth sulfate, and Calfax® DB-45, a sodium dodecyl diphenyl oxide disulfonate, both available from Pilot Chemical Company (Cincinnati, Ohio). In general, the amount of surfactants employed can be from 0.01 to 5%, based on the total amount of the monomers to be polymerized.

Small amounts (e.g., from 0.01 to 2% by weight based on the total monomer weight) of molecular weight regulators, such as a mercaptan, can optionally be used. Such substances are preferably added to the polymerization zone in a mixture with the monomers to be polymerized and are considered part of the total amount of unsaturated monomers used in the polymers.

In the case of polymers derived from styrene and butadiene, the polymer can be produced by high temperature polymerization (e.g., polymerization at a temperature of 40° C. or greater, such as at a temperature of from 40° C. to 100° C.) or by low temperature polymerization (e.g., polymerization at a temperature of less than 40° C., such as at a temperature of from 5° C. to 25° C.). As such, polymers derived from styrene and butadiene can include varying ratios of cis-1,4 butadiene units to trans-1,4 butadiene units.

As described above, polymers derived from styrene and butadiene can be polymerized in a continuous, semi-batch or batch process. Once the desired level of conversion is reached, the polymerization reaction can be terminated by the addition of a shortstop to the reactor. The shortstop reacts rapidly with free radicals and oxidizing agents, thus destroying any remaining initiator and polymer free radicals and preventing the formation of new free radicals. Exemplary shortstops include organic compounds possessing a quinonoid structure (e.g., quinone) and organic compounds that may be oxidized to a quinonoid structure (e.g., hydroquinone), optionally combined with water soluble sulfides such as hydrogen sulfide, ammonium sulfide, or sulfides or hydrosulfides of alkali or alkaline earth metals; N-substituted dithiocarbamates; reaction products of alkylene polyamines with sulfur, containing presumably sulfides, disulfides, polysulfides and/or mixtures of these and other compounds; dialkylhydroxylamines; N,N′-dialkyl-N,N′-methylenebishydroxylamines; dinitrochlorobenzene; dihydroxydiphenyl sulfide; dinitrophenylbenzothiazyl sulfide; and mixtures thereof. In the case of high temperature polymerizations, polymerization can be allowed to continue until complete monomer conversion, i.e., greater than 99%, in which case a shortstop may not be employed.

Once polymerization is terminated (in either the continuous, semi-batch or batch process), the unreacted monomers can be removed from the polymer dispersion. For example, butadiene monomers can be removed by flash distillation at atmospheric pressure and then at reduced pressure. Styrene monomers can be removed by steam stripping in a column.

If desired, polymers derived from styrene and butadiene can be agglomerated, e.g., using chemical, freeze or pressure agglomeration, and water removed to produce a solids content of greater than 50% to 75%.

The examples below are intended to further illustrate certain aspects of the methods and compositions described herein, and are not intended to limit the scope of the claims.

### EXAMPLES

### Two-Part Rapid Cure Coating Compositions

Table 2 shows properties such as tensile and elongation averages of drawdown films for conventional roof coatings (including calcium carbonate filler) and inventive roof coatings (including functional fillers). The first coating component was prepared using the ingredients listed in Table 1 below. The coating compositions when sprayed, passed the Standard Test Method for Tensile Properties of Organic Coatings.

TABLE 1
First Coating Component

| | | Ranges | EX 1 | EX 2 | EX 3 | EX 4 | EX 5 |
|---|---|---|---|---|---|---|---|
| | | Wt | Wt | Wt | Wt | Wt | Wt |
| | Ingredients | (parts) | (parts) | (parts) | (parts) | (parts) | (parts) |
| Pigment | Water | 93-149 | 139 | 140 | 140 | 140 | 140 |
| Grind | Coalescent | 5-10 | 5 | 5 | 5 | 5 | 5 |
| | Dispersant | 3-5.75 | 4 | 4 | 4 | 4 | 4 |
| | In-can | 1.5-6 | 6 | 6 | 6 | 6 | 6 |
| | preservative | | | | | | |
| | Dry film | 0-1.4 | 1 | 1 | 1 | 1 | 1 |
| | preservative | | | | | | |
| | KTPP | 1-1.5 | 1 | 1 | 1 | 1 | 1 |
| | TiO2 | 30-84 | 70 | 70 | 70 | 63 | 70 |
| | Aluminum | 0-100 | | — | — | 7 | — |
| | silicate | | | | | | |
| | Functional filler | 0-500 | | — | — | — | 50-150 |
| | Calcium | 0-502 | 325 | 326 | 261 | 261 | 200-300 |
| | Carbonate (10 | | | | | | |
| | microns) | | | | | | |
| | Calcium | 0-90 | | — | 65 | 65 | — |
| | Carbonate (6 | | | | | | |
| | microns) | | | | | | |
| | Total for Pigment | | 552 | 554 | 554 | 554 | 577 |
| | Grind | | | | | | |
| Additions | Acrylic polymer | 458-587 | 552 | 558 | 558 | 558 | 558 |
| to | dispersion | | | | | | |
| Pigment | Ammonia | 1 | 1 | 1 | 1 | 1 | 1 |
| Grind | Cellulosic | 0-2 | 1 | | | | |
| | Thickener | | | | | | |
| | Associative | 0-4 | | 2 | 2 | 2 | 2 |
| | Thickener | | | | | | |
| | Propylene glycol | 3 | 3 | 3 | 3 | 3 | 3 |
| | Total for Coating | | 1109 | 1116 | 1116 | 1116 | 1139 |
| | Composition | | | | | | |
| | pH | | | 8.87 | 8.84 | 8.85 | 8.79 |
| | Viscosity (#3, | | | 354 | 534 | 590 | 524 |
| | 50 rpm) | | | | | | |
| | % Solids | | | 64.39 | 64.41 | 64.83 | 64.97 |

The first coating component and a second coating component were co-sprayed onto a vertically oriented piece of high density polyethylene using a dual nozzle atomizer. The two-part system was sprayed to a thickness of up to 20 mil. The two-part system adhered to the surface of the substrate with no visible runoff of the coating. Additionally, the coating could be lightly touched within minutes with no transfer of the coating (only water) or damage caused to the surface of the coating. The properties of the resultant coatings are detailed in Table 2 below. The typical thickness of these coatings was 20 mils (dry film thickness).

The water absorption, tensile strength and elongation at break of sprayed films formed by the two-part system described above were measured after fourteen days and after 1,000 hours accelerated weathering in a Xenon arc weatherometer according to the methods described in ASTM D-2370-98(2010), entitled “Standard Test Method for Tensile Properties of Organic Coatings,” which is hereby incorporated by reference in its entirety. Table 2 shows the properties of films according to the Standard Test Method for Tensile Properties of Organic Coatings. The water absorption, tensile strength and elongation at break of the films are shown in Table 2 below.

TABLE 2
Properties of sprayed and drawdown films as exemplified in Table 1.

| | | | | | | | | 7 d | | | | | |
|---|---|---|---|---|---|---|---|---|---|---|---|---|---|
| | | | Coating | Catalyst | | | | W. | Wet | Wet | | Set | |
| | Sample | | Pressure | Pressure | Temp/ | 14 d- | 14 d- | Abs. | Adh. | Adh., | | Time, | |
| Application | I.D | Catalyst | (psi) | (psi) | Humidity | T.S. | Elong | (%) | SPF | Steel | WVP | mins | Texture |
| Spray | EX.1 | Salt | 100 | 30 | 64/73 | 207 | 126 | 30 | 4.02 | N/A | 9 | <10 | 1 |
| Spray | EX.1 | Salt | 1200 | 125 | 64/73 | 258 | 146 | 29 | N/A | N/A | | <10 | 5 |
| Spray | EX.2 | Salt | 350 | 100 | 64/73 | 231 | 130 | 32 | 0.26 | 3.76 | 6 | <10 | 3 |
| Spray | EX.2 | H₃PO₄ | 350 | 100 | 64/73 | 165 | 138 | 14 | 1.24 | 5.14 | 8 | <10 | 3 |
| Spray | EX.3 | Salt | 350 | 100 | 64/73 | 202 | 85 | 20 | 0.4 | 4.35 | | <10 | 3 |
| Spray | EX.3 | H₃PO₄ | 350 | 100 | 64/73 | 146 | 132 | 16 | 0.47 | 1.82 | | <10 | 3 |
| Spray | EX.4 | Salt | 350 | 100 | 64/73 | 218 | 73 | 20 | 0.53 | 5.94 | | <10 | 3 |
| Spray | EX.4 | H₃PO₄ | 350 | 100 | 64/73 | 151 | 124 | 17 | 0.85 | 1.8 | | <10 | 3 |
| Spray | EX.5 | Salt | 350 | 100 | 64/73 | 263 | 78 | 15 | 2.82 | 6.46 | 3 | <10 | 3 |
| Spray | EX.5 | H₃PO₄ | 350 | 100 | 64/73 | 223 | 104 | 12 | 6.97 | 8.96 | 26 | <10 | 3 |
| Drawdown | EX.1 | None | N/A | N/A | 70/50 | 225 | 364 | 10 | 4 | | 13 | >240 | 5 |
| Drawdown | EX.2 | None | N/A | N/A | 70/50 | 225 | 315 | 15 | | 1.71 | 16 | >240 | 5 |
| Drawdown | EX.3 | None | N/A | N/A | 70/50 | 263 | 253 | 12 | | 3.53 | | >240 | 5 |
| Drawdown | EX.4 | None | N/A | N/A | 70/50 | 272 | 201 | 11 | | 2.06 | | >240 | 5 |
| Drawdown | EX.5 | None | N/A | N/A | 70/50 | 339 | 247 | 13 | | 6.24 | 23 | >240 | 5 |

T.S.—tensile strength; Elong.—elongation; W. Abs.—water absorption; WVP—Water Vapor Permeance; Wet Adh. SPF—wet adhesion on sprayed polyurethane foam; Wet Adh. Steel—wet adhesion on steel; salt—multivalent metal salt.

The wet adhesion and dry adhesion of films formed by the two-part system described above to polyurethane foam, aged TPO, steel, and EPDM substrates were measured using a modified version of the methods described in ASTM C-794(2010), entitled “Standard Test Method for Adhesion-in-Peel of Elastomeric Joint Sealants,” which is hereby incorporated by reference in its entirety. The methods described in ASTM C-794 were modified as follows to accommodate the rapid-set nature of the two-part systems. Specifically, these methods employ an embedded scrim sandwiched between two coats of a material undergoing testing. The protocol described in ASTM C-794 was modified such that the first coat of the material undergoing testing (the coat in contact with the substrate) was formed by spraying the two-part system on the substrate, followed by embedding a strip of polyester fabric, while the second coat of the material undergoing testing (the coat applied over the scrim) was applied via a brush over the inlaid strip of polyester fabric. All other aspects of the method were consistent with those described in ASTM C-794. The adhesion of the samples is shown in Table 2.

Sedimentation Stability: The sedimentation stability and viscosity of the first coating formulations were investigated. Coating formulations as described for EX 1 were prepared with various amount of Rheovis 1162. The sedimentation of each formulation was measured by determining the solids content from the top surface of the coating formulations over a 4-day period. The viscosity of the coating formulations as a function of the amount of thickener present was also investigated.

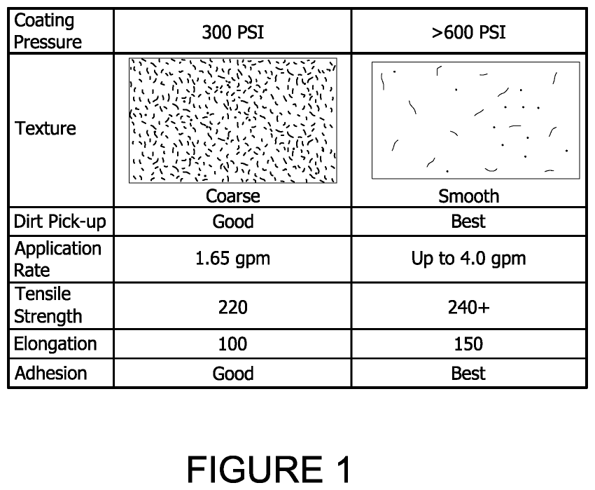

FIG. 1 shows a comparison of the properties of conventional and inventive film when sprayed. Films sprayed at pressures exceeding 600 psi for the first coating component was shown to be smooth.

Summary: The examples provided herein identify catalysts that not only enable rapid film formation of the coating but also significantly reduces the water swelling properties of the coating. This was achieved by using polyphosphoric acid as a catalyst. Water swells were reduced by 70% with the use of phosphoric acid as the catalysts.

The examples also identify rheology modifiers that not only enable the formulation of low viscosity coatings with efficient spray qualities, but also eliminates syneresis typically observed with cellulosic thickeners. This was achieved by using Rheovis 1162, an associative thickener that enables spray efficiency and the elimination of syneresis of the coating upon storage. Rheovis 1162 at a dosage of about 0.2% by weight of the coating essentially eliminated the syneresis of the coating without significantly elevating the viscosity of the coating

Improved mechanical and adhesive properties of the coatings were achieved by selecting a combination of high and low particle size filler in suitable proportions to achieve increased tensile and elongation of the films and enhanced adhesion across diverse substrates. Such benefits were achieved by combining calcium carbonate with functional additives. For example, replacing 25% of a 10 micron calcium carbonate with low particle size functional fillers such as kaolin clay and/or barium sulfate, and/or halloysite, and/or 6 micron calcium carbonate result in about 20% improvement in the tensile and adhesive properties of the coating.

The texture of the coating film was smoother with increasing pressure and so was the coating flow.

### Intumescent Coatings and Insulative Coatings

The composition of various tradename components used herein are as follows: Dispex® Ultra FA 4416 is a wetting/dispersing agent which is a mixture of ionic and non-ionic surfactants, free of APEO, available from BASF; Ti-Pure™ R-900 is a rutile titanium dioxide pigment, available from Chemours Company; Foamstar® ST 2438 is a 100% active defoamer compound combining a hyper-branched star polymer with high-end organo-silicones, available from BASF; Rheovis PU 1235 is a non-ionic associative HEUR thickener, available from BASF; Aerosil® 200 is a hydrophilic fumed silica with a specific surface area of 200 m²/g, available from Evonik Corporation; Melamine is available from Sigma-Aldrich Company; Exolit® APP 422 is a product based on ammonium polyphosphate, crystal modification is phase II, available from Clariant; Charmor® PM40 is a micronized pentaerythritol derivative, available from Perstorp; and Glass Bubbles S32 are lightweight hollow glass microspheres with a density of 0.32 g/cc and a crush strength of 2,000 psi, available from 3M; and a polymer binder (an aqueous based acrylic polymer dispersion having a 55 wt % solids, Brookfield RV viscosity=ca. 300 cps (Spindle #3, 50 rpm, 73 F), available from BASF). The polymer binder comprises a first all acrylic polymer having a Tg of −6° C. and a second all acrylic polymer having a Tg of −28° C.). The polymer binder includes about 26% by weight of a methacrylate monomer, about 70% by weight of an acrylate monomer, about 2% by weight of an acid monomer, and about 2% by weight of a crosslinkable monomer.

Intumescent Composition: In a high-speed disperser with a 2:1 blade, water (166.5 grams) was added and the agitation was set at 2000 rpm. The following were added in the order listed, Dispex Ultra FA 4416 (7.8 grams), Ti-Pure R-900 (58.2 grams), FoamStar ST 2438 (3 grams), Aerosil 200 (7.9 grams), melamine (126 grams), Exolit APP 422 (290.8 grams), Charmor PM40 (106.6 grams) and agitation was continued for 15 minutes. The agitation rate was decreased to 1500 rpm while the polymer binder (55% solids, 153.1 grams) was added. Water (33.9 grams) and diethylene glycol butyl ether (46.3 grams) were added and agitation was continued for 5 minutes. The percent solids were 68.25% with a PVC of about 79.5%. Using a Brookfield LV viscometer, a viscosity of 652 cP was measured using spindle #63 and 60 rpm at 20 C.

Insulative Composition and Coating thereof In a high-speed disperser with a 2:1 blade, water (140 grams) was added and the agitation was set at 2000 rpm. The following were added in the order listed, FoamStar ST 2438 (4 grams), and S32 glass spheres (128 grams). Agitation was continued for 15 minutes. The agitation rate was decreased to 1500 rpm while the polymer binder (55% solids, 80 grams), water (40 grams), and Rheovis PU 1235 (8 grams dissolved in 40 grams of ethylene glycol monobutyl ether (Eastman EB) were added over 2-3 minutes and agitation was continued for 5 minutes. The percent solids were 40.4 weight % with a PVC of 90.6% and viscosity 300 cP.

The resulting composition was spray coated on polycarbonate plaques (Marklon, Bayer). After 30 seconds the coated panels had no material transfer when touched. After 4 hours at ambient temperature the panels had through cured with a DFT of 2-3 millimeters.

Comparative Example 1: Using the procedure described above for preparing the insulative coatings, a coating composition derived from Heat-Flex 3500® Thermal Insulative Coating was prepared. Heat-Flex 3500® Thermal Insulative Coating is a multi-purpose insulative waterborne acrylic coating engineered to optimize thermal properties, offering personnel burn protection and process insulation, available from Sherwin Williams.

Comparative Example 2: Using the procedure described above for preparing the insulative coatings, a coating composition derived from Mascoat® Industrial-DTI was prepared. Mascoat® Industrial-DTI is a composite ceramic and silica-based waterborne acrylic insulating coating that provides an insulating barrier, protects personnel and blocks corrosion all in one application, available from Mascoat.

The thermal conductivity of all panels prepared above was measured according to ASTM C-518 at 75 F. The results are provided in Table 3.

TABLE 3
Thermal Conductivity

| Example | Thermal Conductivity (W/mK) |
|---|---|
| Comparative 1 | 0.097 |
| Comparative 2 | 0.0698 |
| Insulative Composition | 0.0542 |

The results illustrate that the instant insulative compositions can provide coatings with better insulative properties as judged by lower thermal conductivity measurements than commercial insulative compositions at the same film thickness.

The compositions, products, and methods of the appended claims are not limited in scope by the specific compositions, products, and methods described herein, which are intended as illustrations of a few aspects of the claims and any compositions, products, and methods that are functionally equivalent are intended to fall within the scope of the claims. Various modifications of the compositions, products, and methods in addition to those shown and described herein are intended to fall within the scope of the appended claims. Further, while only certain representative composition materials and method steps disclosed herein are specifically described, other combinations of the composition materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. The weight percentages described herein are based on the dry weight of the composition indicated, unless stated otherwise.

1.-71. (canceled)

72. An aqueous coating composition, comprising:
a) a first coating component comprising:
i) from 20% to 60% by weight of a first polymer, based on the dry weight of the first coating component; and
ii) from 10% to 75% by weight of a filler, based on the dry weight of the first coating component, and
b) a second coating component comprising a phosphoric acid catalyst, wherein the phosphoric acid catalyst is present in an amount of less than 5% by weight, based on the weight of the aqueous coating composition.

73. An aqueous coating composition comprising a first coating component, wherein the first coating component comprises:
i) from 20% to 60% by weight of a first polymer, based on the dry weight of the first coating component;
ii) at least 10% by weight of a functional filler, based on the dry weight of the first coating component, wherein the functional filler is selected from kaolin, halloysite, barium sulfate, calcium carbonate, or a mixture thereof, wherein the functional filler has an average particle size diameter of 3 microns or less, as determined by Sedigraph 5100 Particle Size Analyzer; and
iii) an additional filler having an average particle size diameter of 10 microns or greater, as determined by Sedigraph 5100 Particle Size Analyzer.

74. An aqueous coating composition, comprising:
a) a first coating component comprising:
i) from 20% to 60% by weight of a first polymer, based on the dry weight of the first coating component;
ii) at least 10% by weight of a functional filler, based on the dry weight of the first coating component, wherein the functional filler is selected from kaolin, halloysite, barium sulfate, calcium carbonate, or a mixture thereof, wherein the functional filler has an average particle size diameter of 3 microns or less, as determined by Sedigraph 5100 Particle Size Analyzer; and
iii) an additional filler having an average particle size diameter of 10 microns or greater, as determined by Sedigraph 5100 Particle Size Analyzer, and
b) a second coating component comprising a film forming catalyst.

75. The composition of claim 73, wherein the functional filler includes kaolin.

76. The composition of claim 72, wherein the first coating component further comprises a thickener.

77. The composition of claim 72, wherein the first coating component further comprises an additive selected from a coalescent agent, a pigment dispersant, a defoamer, a wetting agent, an adhesion promoter, or a combination.

78. A sprayed film, comprising:
a) from 25% to 75% by weight, based on a dry weight of the sprayed film, of a first polymer selected from an acrylic homopolymer or an acrylic copolymer;
b) from 10% to 70% by weight of a functional filler, based on the dry weight of the sprayed film, wherein the functional filler is selected from kaolin, halloysite, barium sulfate, calcium carbonate, or a mixture thereof, wherein the functional filler has an average particle size diameter of 3 microns or less, as determined by Sedigraph 5100 Particle Size Analyzer, and
c) an additional filler having an average particle size diameter of 10 microns or greater, as determined by Sedigraph 5100 Particle Size Analyzer;
wherein the sprayed film, passes the Standard Specification for Liquid Applied Acrylic Coating test set forth in ASTM D 6083-97.

79. A sprayed film, comprising:
a) from 25% to 75% by weight, based on a dry weight of the sprayed film, of a first polymer selected from an acrylic homopolymer or an acrylic copolymer;
b) from 20% to 70% by weight, based on the dry weight of the sprayed film, of a filler, and
c) less than 5% by weight, based on the dry weight of the sprayed film, of a phosphoric acid catalyst,
wherein the sprayed film, passes the Standard Specification for Liquid Applied Acrylic Coating test set forth in ASTM D 6083-97.

80. The sprayed film of claim 78, wherein the first polymer is selected from an acrylic homopolymer, an acrylic-based copolymer, a styrene-acrylic-based copolymer, a styrene-butadiene-based copolymer, a vinyl acrylic-based copolymer, a vinyl aromatic-based copolymer, an ethylene vinyl acetate-based copolymer, a polychloroprene, an alkyd resin, a polyester resin, a polyurethane resin, an epoxy resin, or a blend thereof.

81. The sprayed film of claim 78, further comprising a thickener.

82. A coating comprising the composition of claim 72.

83. The coating of claim 82 selected from a roof coating, an architectural coating, or an industrial coating.

84. A barrier coating comprising a composition of claim 72, wherein the barrier coating when sprayed and dried, exhibits barrier properties to air, water vapor, or liquid water.

85. A barrier coating composition comprising:
a) from 20% to 85% by weight of a first polymer, based on the dry weight in the barrier composition;
b) rom 10% to 70% by weight of a filler, based on the dry weight in the barrier composition;
c) less than 5% by weight of a phosphoric acid catalyst, based on the dry weight in the barrier composition; and
d) one or more additives selected from a coalescent agent, a pigment dispersant, a defoamer, a wetting agent, an adhesion promoter, or a combination,
wherein the barrier coating composition when dried, exhibits barrier properties to air, water vapor, or liquid water.

86. The barrier composition of claim 85, wherein the filler comprises a functional filler selected from kaolin, halloysite, barium sulfate, calcium carbonate, or a mixture thereof, wherein the functional filler has an average particle size diameter of 3 microns or less, as determined by Sedigraph 5100 Particle Size Analyzer.

87. A method of coating a surface comprising applying an aqueous coating composition to the surface, wherein the aqueous coating composition comprises
a) from 25% to 75% by weight, based on a dry weight of the sprayed film, of a first polymer selected from an acrylic homopolymer or an acrylic copolymer;
b) from 10% to 70% by weight of a functional filler, based on the dry weight of the sprayed film, wherein the functional filler is selected from kaolin, halloysite, barium sulfate, calcium carbonate, or a mixture thereof, wherein the functional filler has an average particle size diameter of 3 microns or less, as determined by Sedigraph 5100 Particle Size Analyzer, and
c) an additional filler having an average particle size diameter of 10 microns or greater, as determined by Sedigraph 5100 Particle Size Analyzer,
wherein the aqueous coating composition is applied at a pressure of from 800 psi to 2,500 psi.

88. A method of coating a surface comprising applying an aqueous coating composition to the surface,
wherein the aqueous coating composition comprises a) a first coating component including i) from 20% to 60% by weight of a first polymer, based on the dry weight of the first coating component; and ii) from 10% to 70% by weight of a filler, based on the dry weight of the first coating component, and b) a second coating component including a film forming catalyst, wherein the first coating component is applied at a pressure of from greater than 300 psi to 1,500 psi, and
the second coating component is applied at a pressure of from 30 psi to 300 psi to the surface.

89. The method of claim 88, wherein the first coating component and the second coating component are simultaneously applied to the surface.

90. The method of claim 87, wherein the surface is metal, asphalt, wet or dry concrete, stone, ceramic, wood, plastic, polyurethane foam, glass, masonry or cinder block, stucco, manufactured board (e.g., cement board, gypsum board, expanded polystyrene (EPS) board, an oriented strand board (OSB)), or another coating layer applied on a substrate.

91. The method of claim 87, wherein the surface is a roof or a wall surface.
